(19) United States
(12) Patent Application Publication
(10) Pub. No.: US 2025/0277320 A1
(43) Pub. Date: Sep. 4, 2025

(54) SYSTEMS AND METHODS FOR MXENE HETEROSTRUCTURES

(71) Applicant: UCHICAGO ARGONNE, LLC, Chicago, IL (US)

(72) Inventors: Zachary David Hood, Bolingbrook, IL (US); Sixbert Picard Muhoza, Bolingbrook, IL (US); Shiba Prasad Adhikari, Lisle, IL (US)

(73) Assignee: UCHICAGO ARGONNE, LLC, Chicago, IL (US)

(21) Appl. No.: 18/595,320

(22) Filed: Mar. 4, 2024

(51) Int. Cl. C25B 11/032; C25B 1/23; C25B 9/23; C25B 9/75; C25B 9/77; C25B 11/081; C25B 15/08

(52) U.S. Cl. CPC C25B 11/032; C25B 1/23; C25B 9/23; C25B 9/75; C25B 9/77; C25B 11/081; C25B 15/083; C25B 15/087

(57) ABSTRACT

A material can include a MXene. The material can include a first metal adsorbed on the MXene. The material can include a second metal adsorbed on the MXene. The second metal can be different from the first metal.

### STATEMENT OF GOVERNMENT INTEREST

This invention was made with government support under Contract No. DE-AC02-06CH11357 awarded by the United States Department of Energy to UChicago Argonne, LLC, operator of Argonne National Laboratory. The government has certain rights in the invention.

### TECHNICAL FIELD

The present disclosure relates generally to MXenes, a family of two-dimensional transition metal carbides, nitrides, and/or carbonitrides.

### BACKGROUND

Net zero carbon emissions can be a foundational factor for limiting global warming.

### SUMMARY

One aspect of the present disclosure is directed to a material. The material can include a MXene. The material can include a first metal adsorbed on the MXene. The material can include a second metal adsorbed on the MXene. The second metal can be different from the first metal.

Another aspect of the present disclosure is directed to a method. The method can include mixing one or more metal salts in solution and a dispersion of a native MXene to form a functionalized MXene mixture. The functionalized MXene mixture can include a first metal and a second metal adsorbed on the native MXene. The method can include filtering the functionalized MXene mixture to form a filtered functionalized MXene mixture. The method can include drying the filtered functionalized MXene mixture to form a functionalized MXene material.

Another aspect of the present disclosure is directed to a system. The system can include an electrode. The electrode can include a plurality of MXene particles. The electrode can include a binder. The binder can electrically couple the plurality of MXene particles to each other and to a substrate. The binder can include a fluoropolymer.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through the use of the accompanying drawings.

FIG. 1 illustrates the synthesis of a Cu/MXene heterostructure, according to an example implementation.

FIG. 2A is a schematic diagram of the reductive adsorption process, according to an example implementation.

FIG. 2B illustrates high-resolution STEM images and corresponding EDS elemental images for Cu(5%)/MXene, according to an example implementation.

FIG. 2C illustrates a high-magnification STEM image showing the Cu nanoparticles along with EDS element images, according to an example implementation.

FIG. 3A illustrates high-resolution Cu 2p XPS spectra before and after Cu loading on MXene, according to an example implementation.

FIG. 3B illustrates high-resolution Ti 2p XPS spectra before and after Cu loading on MXene, according to an example implementation.

FIG. 3C illustrates XPS spectra showing Ti 2p regions for MXene and Cu/MXene with different amounts of copper loadings, according to an example implementation.

FIG. 3D illustrates a reductive adsorption process, according to an example implementation.

FIG. 4A illustrates a schematic diagram of an H-cell, according to an example implementation.

FIG. 4B illustrates a MXene-coated carbon electrode, according to an example implementation.

FIG. 4C illustrates LSVs of different MXene-decorated carbon electrodes, according to an example implementation.

FIG. 4D illustrates the current densities at different voltages with different Ti₃C₂Tₓ MXene-modified electrodes, according to an example implementation.

FIG. 5A illustrates the faradaic efficiency for different gas products for MXene electrodes, according to an example implementation.

FIG. 5B illustrates the faradaic efficiency for different gas products for Cu(5%)/MXene modified electrode, according to an example implementation.

FIG. 5C illustrates the faradaic efficiency of the different hydrocarbons observed as a function of applied potentials with MXene and Cu/MXene samples, according to an example implementation.

FIG. 5D illustrates current density vs. time during chronoamperometric electrolysis, according to an example implementation.

FIG. 6 illustrates a MXene/metal heterostructure, according to an example implementation.

FIG. 7 illustrates SEM images for the MAX phase, pristine MXene, and MXene heterostructures, according to an example implementation.

FIG. 8A illustrates a synthesis procedure entailing selective etching of the MAX phase and reductive adsorption of the metals onto Ti₃C₂Tₓ, according to an example implementation.

FIG. 8B illustrates PXRD patterns of the MAX phase, pristine MXene, and MXene heterostructures, according to an example implementation.

FIG. 8C illustrates high magnification STEM and EDS of the MXene heterostructures, according to an example implementation.

FIG. 8D illustrates a Cu 2p XPS spectra of the MXene heterostructures, according to an example implementation.

FIG. 8E illustrates characteristic metal (M) XPS spectra of the MXene heterostructures, according to an example implementation.

FIG. 8F illustrates standard reduction potentials of adsorbed metals and Ti, according to an example implementation.

FIG. 9A illustrates a Ti 2p XPS spectra of the pristine MXene and MXene heterostructures, according to an example implementation.

FIG. 9B illustrates a HAADF STEM image, EDS, and electron diffraction of Ti₃C₂Tₓ/CuAg, according to an example implementation.

FIG. 9C illustrates an O 1s XPS spectra of the pristine MXene and MXene heterostructures, according to an example implementation.

FIG. 9D illustrates a mechanism for reductive adsorption of Cu and secondary metals (M) onto Ti₃C₂Tₓ, according to an example implementation.

FIG. 10A illustrates a method of electrode assembly, according to an example implementation.

FIG. 10B illustrates F 1s and C 1s XPS spectra of MXene powder and slurry samples, according to an example implementation.

FIG. 10C illustrates SEM cross-sectional images of MXene electrodes, according to an example implementation.

FIG. 11A illustrates LSVs of MXene and bare carbon electrodes in CO₂ saturated 1M KHCO₃ at cell potentials of 0 to −4 V, according to an example implementation.

FIG. 11B illustrates GC gas chromatograms showing product distribution for all MXene electrocatalysts at low cell potential (−2.5 V) versus high potential (−4 V), according to an example implementation.

FIG. 11C illustrates evolution of the products generation efficiency for each studied electrocatalyst as a function of cell potential, according to an example implementation.

FIG. 12 illustrates SEM images for the electrode slurry including a binder with pristine MXene and MXene heterostructures, according to an example implementation.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Before turning to the figures, which illustrate certain exemplary embodiments in detail, it should be understood that the present disclosure is not limited to the details of methodology set forth in the description or illustrated in the figures. It should also be understood that the terminology used herein is for the purpose of description only and should not be regarded as limiting.

### I. Overview

Carbon dioxide (CO₂) capture and sequestration, along with industrial decarbonization, holds tremendous potential for mitigating the current energy and environmental challenges. In this context, the electrochemical conversion of CO₂ using off-grid power can be an effective strategy to establish a more sustainable carbon cycle. Liquid fuels produced via the electrocatalytic reduction of carbon dioxide (CO2RR) can efficiently store wind and solar energy, mitigating their intermittent nature. When executed efficiently, this process can significantly diminish dependence on fossil fuels and, consequently, reduce greenhouse gas (GHG) emissions.

The electrocatalytic CO₂RR is a complex process involving multiple electron/proton transfers and has the capability to convert CO₂ into various gaseous and liquid products, including carbon monoxide (CO), formaldehyde (HCHO), formic acid (HCOOH), hydrocarbons (CH₄ and C₂H₄), and alcohols (CH₃OH and C₂H₅OH). The specific products formed depend on factors such as the type of electrocatalysts employed, the applied potential, and the electrolyte used during the process. The mechanism of CO₂RR involves (i) the adsorption and activation of CO₂, (ii) the activated CO₂ is reduced to a reactive radical anion, which undergoes protonation, coupling, or further electron transfers, and (iii) the formation of the product, the nature of which depends on the reaction conditions, catalyst, and applied potential. When the catalyst exhibits a strong binding energy for CO, it can lead to the formation of C₁ intermediates on the catalyst's surface. These intermediates can undergo further hydrogenation to produce CH₄ or react with adsorbed oxygen or water to yield oxygenated products such as formaldehyde and formic acid. On the other hand, these intermediates may react with each other to form multicarbon (C₂₊) products, such as ethanol, ethylene, and n-propanol. Achieving high selectivity for C₁ or C₂₊ products during CO₂RR can be a goal in the field of electrocatalysis, as it opens up new avenues for creating cleaner and more efficient energy conversion processes and addressing environmental and energy challenges.

Although significant advances have been achieved in the electrocatalytic reduction of CO₂, many challenges such as low energy efficiency, slow electron transfer kinetics, unsatisfactory or complete lack of selectivity, and electrocatalysts' deactivation need to be overcome to facilitate adoption and commercialization. Therefore, there is currently a strong emphasis on the design and synthesis of electrocatalysts that are not only robust and cost-effective but also exhibit high selectivity for CO₂RR. In addition, when CO₂RR is performed in aqueous solutions, as is often the case, the competing hydrogen evolution reaction (HER) adds significant challenges.

Layered (2D) materials have garnered significant attention as promising electrochemical catalysts, primarily because of their unique structural and electronic properties. The layers in these materials possess vacancies which along with the structural disorder usually associated with layered structures reduces the coordination number of surface atoms, leaving dangling bonds that promote chemisorption of reactants, which result in enhanced catalytic performance. Moreover, control of the defects can be used to tailor the electronic structure of these materials toward specific catalytic reactions. Additionally, their large surface area, high crystallinity, and tunable electronic properties make them attractive candidates for enhancing catalytic activity and selectivity in various electrochemical reactions. Diverse 2D materials ranging from metals, metal oxides, chalcogenides, and even metal-free catalysts can have the potential for electrocatalytic CO₂ reduction.

Among the various 2D materials, a class of transition metal carbides/nitrides called MXenes has emerged as a highly promising group. MXenes have a general formula of Mₙ₊₁XₙTₓ (1≤n≤4), where M represents an early transition metal, X represents carbon and/or nitrogen, Tₓ (or T) represents surface termination groups such as —O, —OH, —F, etc. Tₓ can be present in an amount based on charge balance of the MXene. The tunable surface chemistry, as well as the ordered structure of MXenes, may allow for tailoring the binding of intermediates needed for CO₂ reduction and C—C coupling necessary in the formation of C₁, C₂, C₂₊ products.

MXenes are a family of two-dimensional carbides, nitrides, and carbonitrides. They possess metallic electronic conductivity, large surface area, and versatile surface chemistry, all of which are desirable properties for electrocatalytic processes. As illustrated by their general formula, Mₙ₊₁XₙTₓ, MXenes include n+1 layers of early transition metals (M) interleaved with n layers of carbon and/or nitrogen (X) with the outer layers terminated by a variety of surface groups (Tₓ=O, OH, F, etc.).

CO₂RR activity can be investigated using the electrocatalysts obtained from the reductively adsorbed metals such as Cu on Ti₃C₂Tₓ MXene. Formaldehyde (HCHO) can be the main CO₂RR product with a maximum Faradaic Efficiency (FE) of 40.98% at −3.6V while using 5% Cu/MXene on the 1M KHCO₃ electrolyte. HER can be a competing side reaction with significant amounts of hydrogen at different voltages. The production of HCHO and H₂ can be modulated by adjusting the applied voltages. The reductive introduction of copper can help to suppress the HER activity and enhance the production of some hydrocarbons (e.g., CH₄, C₂H₄, and C₂H₆).

Ti₃C₂Tₓ can be hybridized with a range of CuM bimetallic species for CO₂RR catalysis. Copper-based electrocatalysts can produce a variety of products, including C₂₊ products. However, they can suffer from low selectivity of single products due to their moderate binding affinity towards many CO₂RR intermediates which favors multiple reaction pathways and leads to multiple products at once. The product selectivity can be enhanced by alloying Cu with secondary metals to narrow the range of CO₂RR intermediates bound by the resulting hybrid catalysts, reducing the number of favored CO₂RR pathways and products. As such, six Ti₃C₂Tₓ/CuM (M=Ag, Sn, Zn, Ru, Ni, and Fe) heterostructures can be developed and their properties can be contrasted with those of Ti₃C₂Tₓ/Cu and bare Ti₃C₂Tₓ baselines. The six CuM combinations can be selected based on the binding affinity of the M species towards *CO and *H intermediates, with one group possessing lower binding affinity than Cu for both intermediates (Ag, Sn, Zn) and the other group the opposite (Ru, Ni, Fe).

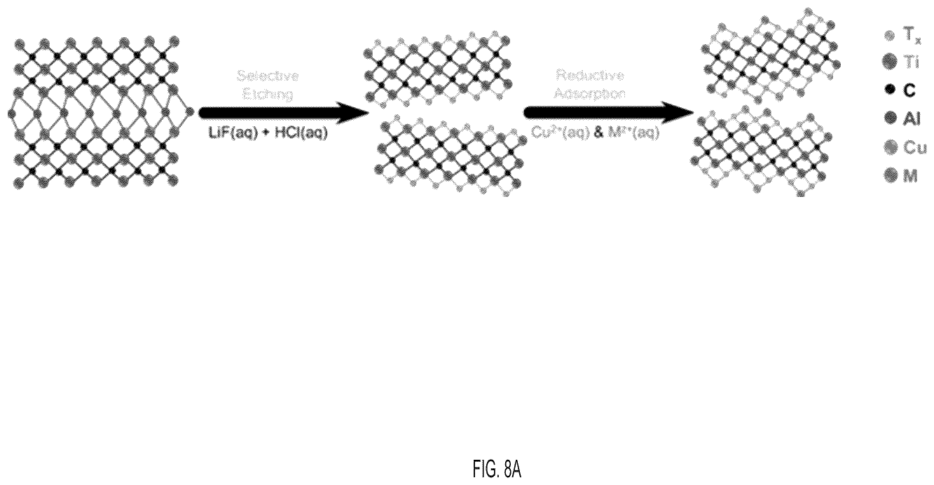

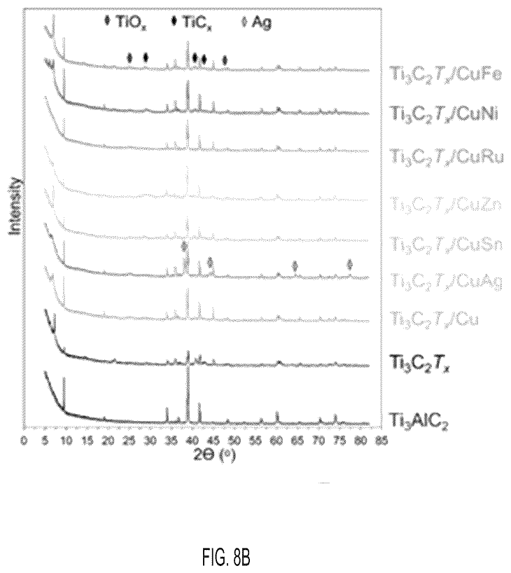

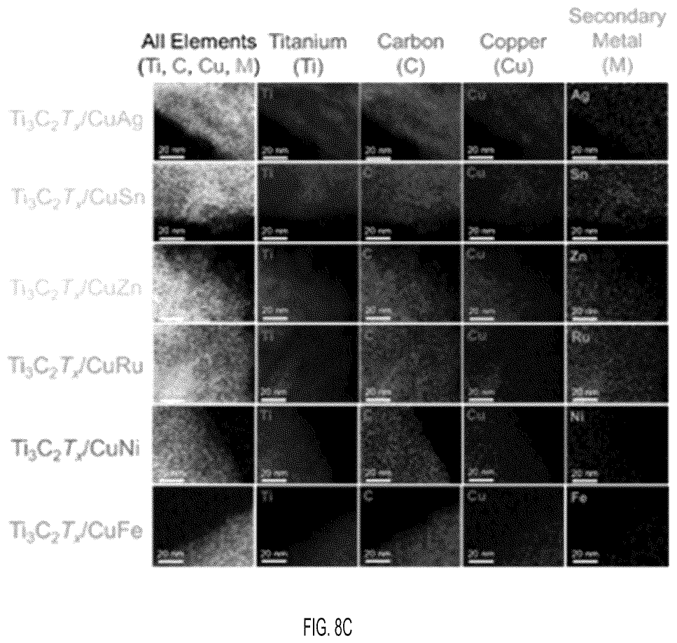

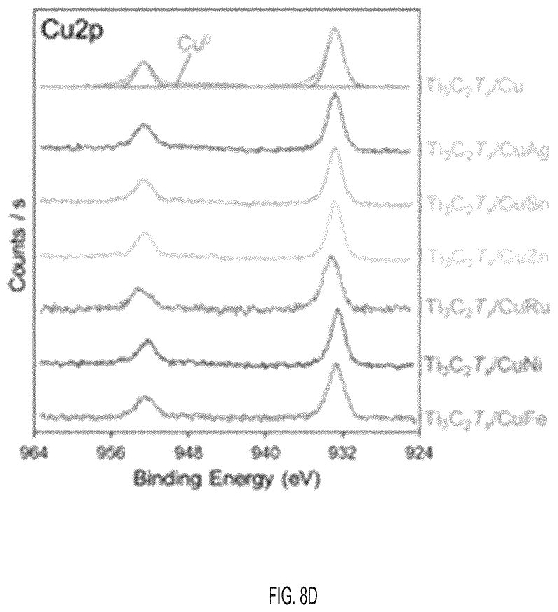

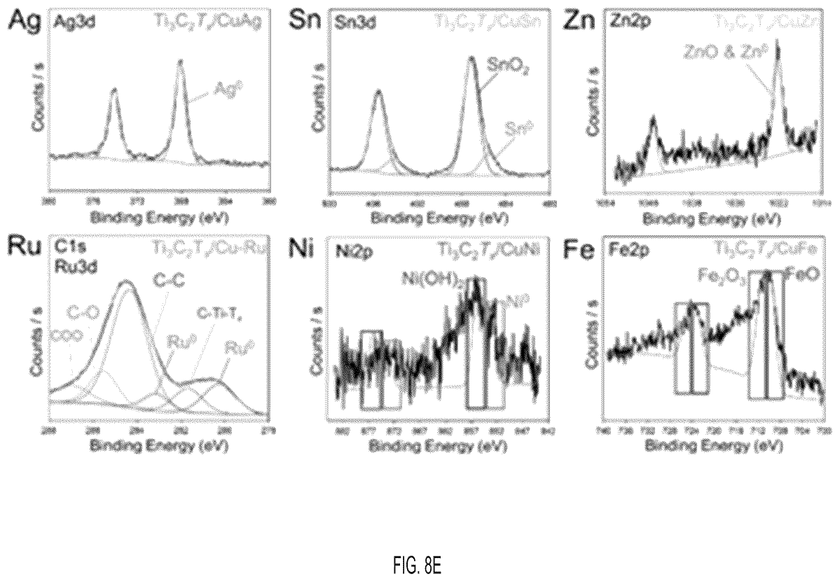

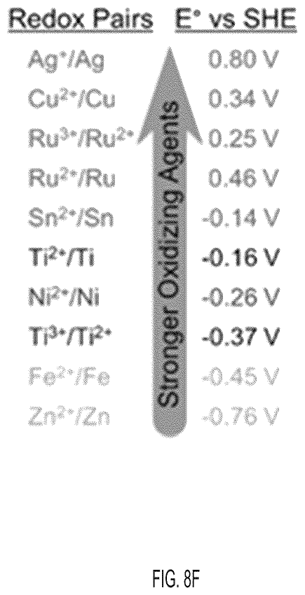

The metals can be adsorbed onto the MXene by drawing electrons from its core, a process that can be termed “reductive adsorption”. This metals adsorption can be illustrated by scanning transmission electron microscopy (S/TEM) and x-ray photoelectron spectroscopy (XPS) shown in FIGS. 8C-8E. When applied to CO₂RR, these Ti₃C₂Tₓ/CuM electrocatalysts can result in a narrow product distribution with only two products being observed (hydrogen and formaldehyde) and achieve high selectivity at low cell potentials. The production of formaldehyde is not typically achieved through electrochemical CO₂RR as oxidation of the formaldehyde level intermediate (*CH₂O) to its methanol counterpart (*CH₃O) is generally thermodynamically favored. Thus, the herein disclosed production of formaldehyde can be indicative that the Ti₃C₂Tₓ/CuM heterostructures have altered the adsorption dynamics of CO₂RR intermediates and rendered *CH₂O oxidation less favorable than its desorption. Formaldehyde can be generated across the MXene heterostructures with optimum efficiency observed at low, industry-preferred, potentials (−1.4 V and −2.2 V).

### II. Overview of Systems and Methods for Adsorption of Metals on MXenes

The electrocatalytic carbon dioxide reduction reaction (CO₂RR) is a promising technology to mitigate the greenhouse effect as it can be used to convert excess CO₂ in the atmosphere to fuel and other chemicals. One hurdle for this technology to be viable is that the catalytic selectivity towards specific C₁ and C₂ products should be enhanced. The preparation, characterization, and performance of new Cu-based MXene electrocatalysts that overcome the preparation and CO₂RR selectivity issues are disclosed herein. The synthesis of these electrocatalysts can leverage reductive adsorption of Cu(II) ions onto oxo-/hydroxo-terminated Ti₃C₂Tₓ (Tₓ=—O, —OH etc.) that yields tunable structure. The reductive Cu(0) loading on the two-dimensional MXenes can alter the electrochemical performances of pristine MXenes. The Cu(5%)/MXene electrocatalyst can yield formaldehyde (HCHO, C₁ product) as the main product during CO₂RR with a Faradaic Efficiency (FE) of 40.98% at −3.6 V applied potential. Additionally, some C₂ products (ethanol, and acetaldehyde) can be detected with these copper-decorated MXenes.

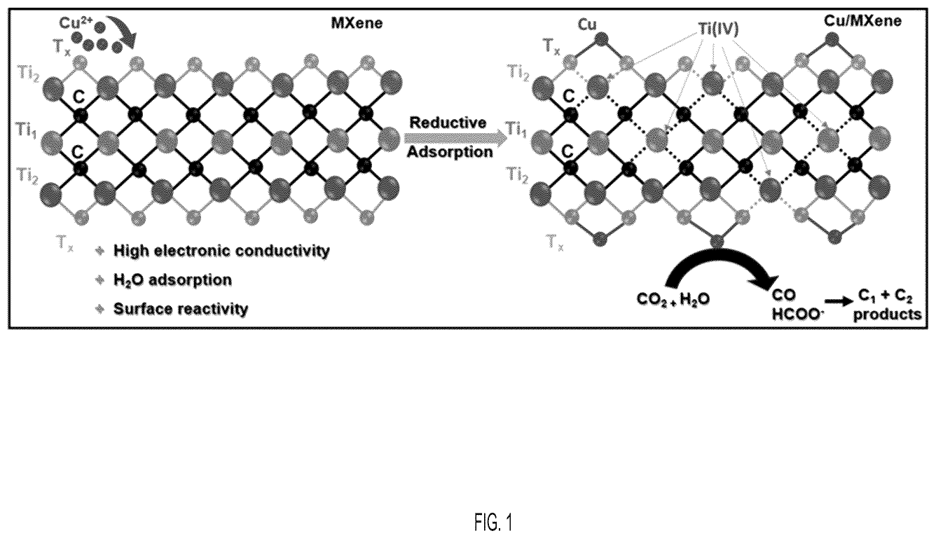

FIG. 1 illustrates the synthesis of a Cu/MXene heterostructure. The synthesis of the Cu/MXene heterostructure can include a reductive adsorption method. This method can include using a Ti₃C₂Tₓ MXene suspension and a copper nitrate solution. The suspension and the solution can be formed at room temperature. The system and methods of the present disclosure can include engineering MXene-based electrocatalysts. These catalysts can catalyze CO₂ reduction reactions and generate both C₁ products (e.g., formaldehyde) and C₂ products (e.g., ethanol, acetaldehyde). The MXene-based electrocatalysts can have exceptional catalytic activity and long-term stability. The MXene-based electrocatalysts can have applications in sustainable carbon conversion.

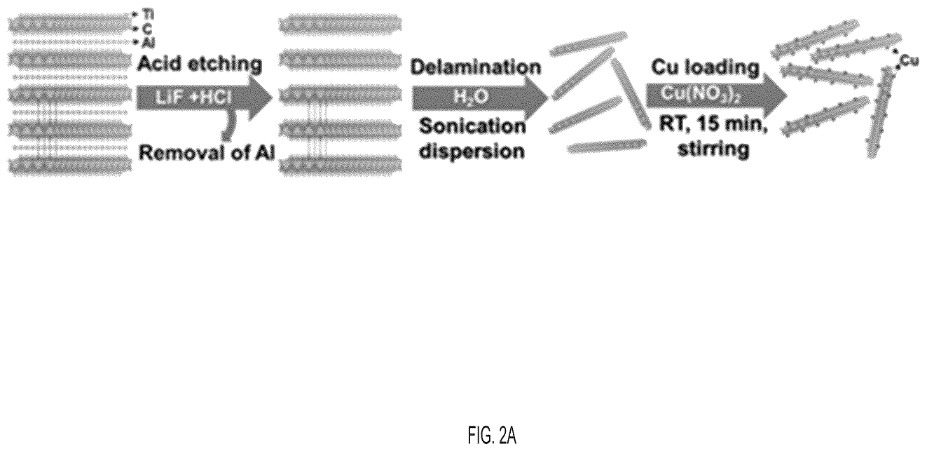

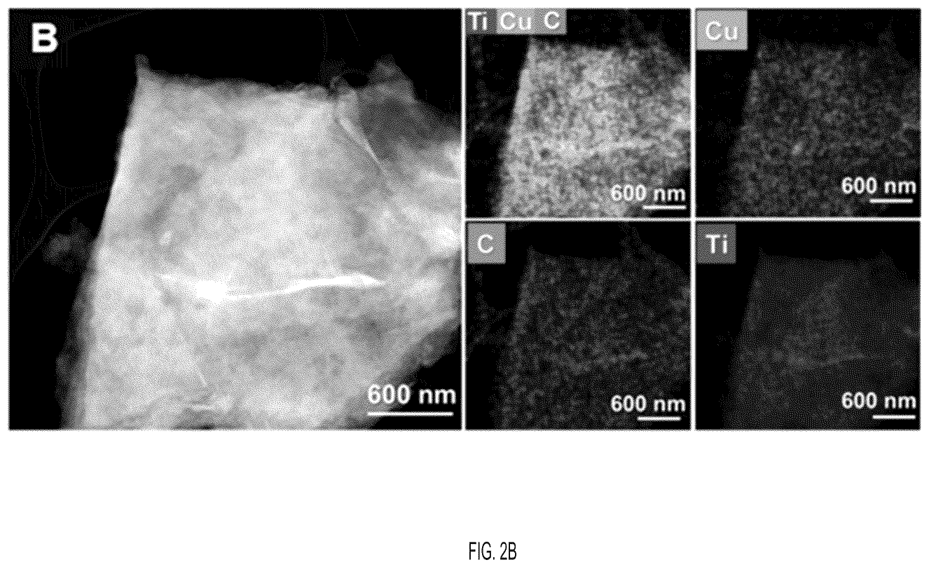

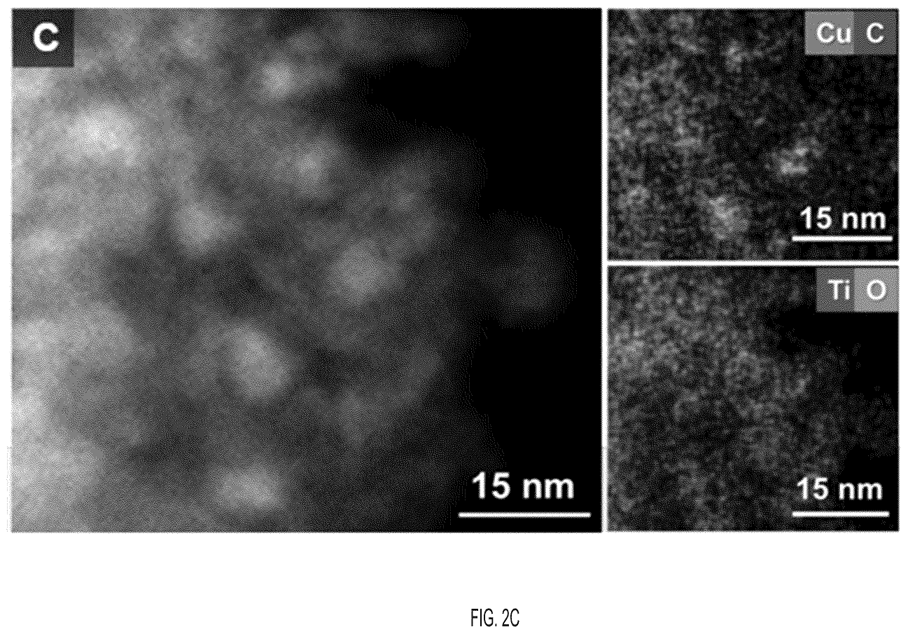

In the process of reductive adsorption of metal ions onto Ti₃C₂Tₓ MXene, the initial step can involve defining a precursor chemistry that includes a MXene and a metal ion. The metal ion can be selected based on the desired target chemistry. Subsequently, these components (e.g., MXene and metal ion) can be dispersed in an aqueous solution. In the case of reductive adsorption of copper on MXene, a wet chemical procedure can be used, as illustrated in FIG. 2A. FIG. 2A illustrates a schematic diagram of the reductive adsorption process.

Ti₃C₂Tₓ MXene nanosheets can be synthesized using a gentle acid etching method on the Ti₃AlC₂ MAX phase. The gentle acid etching method can use an aqueous solution of LiF and HCl. Afterward, the MXene dispersion prepared in water can be combined with aqueous copper nitrate (with varying concentrations based on the Cu/Ti molar ratio) and stirred for 15 minutes at 25° C. before filtering to obtain the Cu-decorated MXene. Throughout the reaction, nucleated copper can adhere to the surface of MXene nanosheets through a reductive adsorption process. During this process, the Ti species in MXene can oxidize to TiO₂ to facilitate the reduction of Cu on the surface.

The scanning electron microscopy images of freshly prepared MXenes can depict the layered structures with micron-sized flakes. A high-resolution STEM study, coupled with EDS elemental mapping, can reveal the even distribution of C and Ti in Ti₃C₂ MXene nanoflakes.

FIG. 2B illustrates high-resolution STEM images and corresponding EDS elemental images for Cu(5%)/MXene. The STEM image of 5% Cu-loaded MXene and the accompanying EDS mapping can reveal a uniform distribution of copper on the MXene's surface, as shown in FIG. 2B, while retaining the MXene flake morphology. A 5% Cu-loaded MXene can be selected due to its notable electrochemical performance.

FIG. 2C illustrates a high-magnification STEM image showing the Cu nanoparticles along with EDS element images. High-resolution STEM images of the 5% Cu-loaded MXenes can display pseudo-spherical Cu nanoparticles (e.g., approximately 2-5 nm in size) uniformly dispersed across the surface of the MXene nanosheets, as depicted in FIG. 2C. Furthermore, STEM analysis can reveal the presence of both crystalline and amorphous regions. The crystalline regions may originate from TiO₂ and can be indexed to the (100) and (010) inter-reticular planes of the anatase phase, as indicated by an electron diffraction (SAED) pattern. As the amount of Cu loading increases, a rise in the number of Cu particles dispersed over the MXene surface can be observed. This can be attributed to the agglomeration of copper nanoparticles.

MAX, MXene, and Cu-decorated MXene can be analyzed using X-ray diffraction (XRD). The XRD patterns of the parent MAX phase can correspond to those of the well-established Ti₃AlC₂. Thus, the peak observed at 2θ=10° can correspond to (002), and the one found at 2θ=40° can correspond to (104). After MXene formation during the mild acid etching process, the intensity of most diffraction peaks of the parent MAX can decrease significantly, indicating the nanoscale nature of the materials due to delamination. The XRD pattern of Cu-decorated MXene and original MXene can be similar and suggest that the crystal structure of MXene is maintained during the reductive Cu loading. Additionally, no additional copper peaks are observed, indicating that the copper nanoparticles are dispersed on the surface, as confirmed by microscopic studies.

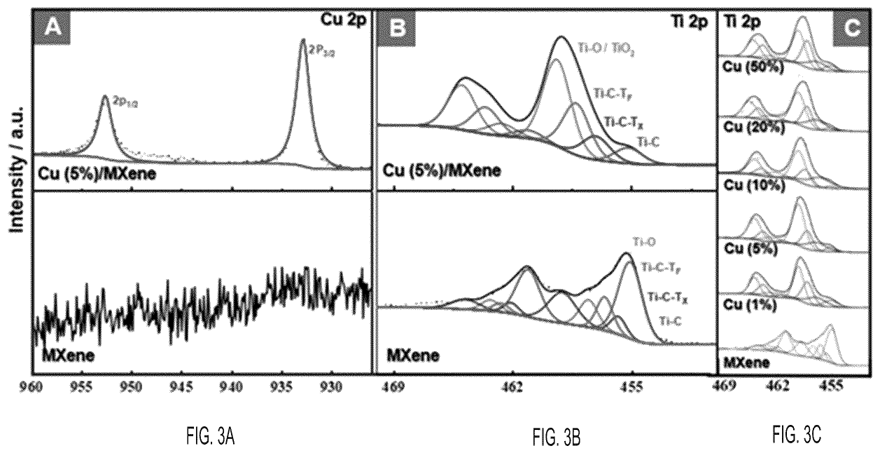

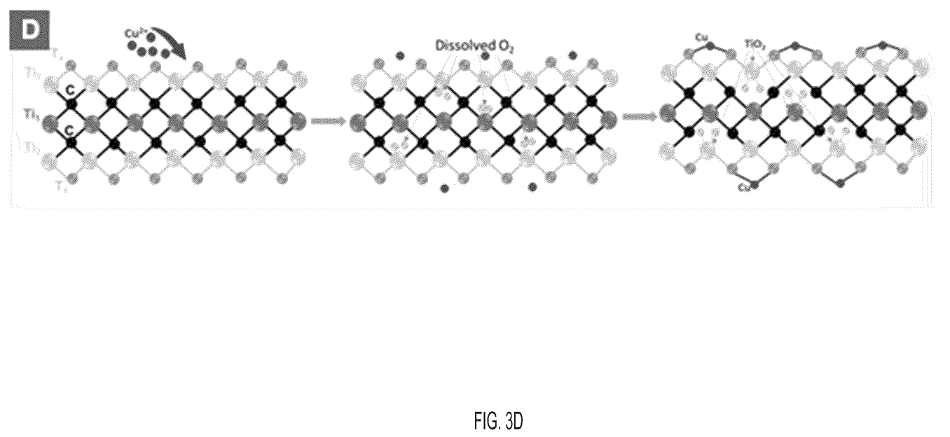

X-ray photoelectron spectroscopy (XPS) can be used to investigate the elemental composition, oxidation states, and local coordination environment of the species within the MXene nanosheets both before and after Cu loading. The Cu 2p doublet observed at (932.5 and 952.2 eV, corresponding to Cu 2p_{3/2} and Cu 2p_{1/2}, respectively) can confirm the presence of metallic Cu. No satellite peaks (942 and 940 eV) or other peaks related to Cu²⁺ (933.1 eV) or Cu⁺ (932.7 eV) were observed, indicating that Cu²⁺ from the aqueous nitrate solution was completely reduced to Cu(0) at the surface of the MXene, as shown in FIG. 3A. Furthermore, no peaks related to N 1s were observed. FIG. 3A illustrates high-resolution Cu 2p XPS spectra before and after Cu loading on MXene.

FIG. 3B illustrates high-resolution Ti 2p XPS spectra before and after Cu loading on MXene. The Ti 2p region on the bare MXene, as shown in FIG. 3B, can exhibit a broad peak around 455 eV, corresponding to Ti—C. The peak at a higher binding energy, around 459 eV, can correspond to the presence of Ti—O species, indicating an oxidized surface. Additionally, within the Ti 2p region, the deconvolution can reveal other peaks at around 457 eV for Ti—C—O species and 458 eV for Ti—C—X species, where X represents the surface termination, which may include O, OH, or F. After the Cu loading, the Ti 2p peaks can shift toward higher binding energy, indicating the incorporation of Cu on the MXene site. Furthermore, following the Cu modification, the intensity of the Ti—C peak (around 455 eV) decreases, while the intensity of the Ti—O peak (around 457 eV) increases. Additionally, significant differences in the O 1s and C 1s peaks can be observed before and after Cu loading, further supporting the incorporation of Cu on the MXene surface.

FIG. 3C illustrates XPS spectra showing Ti 2p regions for MXene and Cu/MXene with different amounts of copper loadings. Samples with increasing copper contents can exhibit a decrease in the titanium carbide peak (around 455 eV) alongside an increase in Ti—O/TiO₂ species, as shown in FIG. 3C. XPS analysis can demonstrate the presence of TiO₂ following the reductive adsorption of Cu on MXene, in addition to the observation of the nanoparticle nature of copper. Furthermore, the parent MXene can include several non-crystalline regions due to the accumulation of amorphous carbon, as indicated by the microscopic study.

FIG. 3D illustrates a reductive adsorption process. The reductive adsorption of copper on MXene can include the following mechanism. Cu²⁺ ions from the copper nitrate solution can be attracted to the surface terminations (—O, —OH) at the edge sites of the MXene dispersion. Simultaneously, the titanium in the basal plane can oxidize itself to create fresh TiO₂, aided by dissolved oxygen in water, ensuring a continuous supply of electrons, as illustrated in FIG. 3D. On the surface, Cu²⁺ can accumulate additional electrons as it nucleates into nanoparticles that extend from the basal plane. The reduction of copper and the oxidation of titanium at the surface can mutually reinforce each other, spreading the reaction across the entire MXene surface. These interconnected reactions can result in thermodynamically stable products, indicating a minimal degree of reversibility in the reaction.

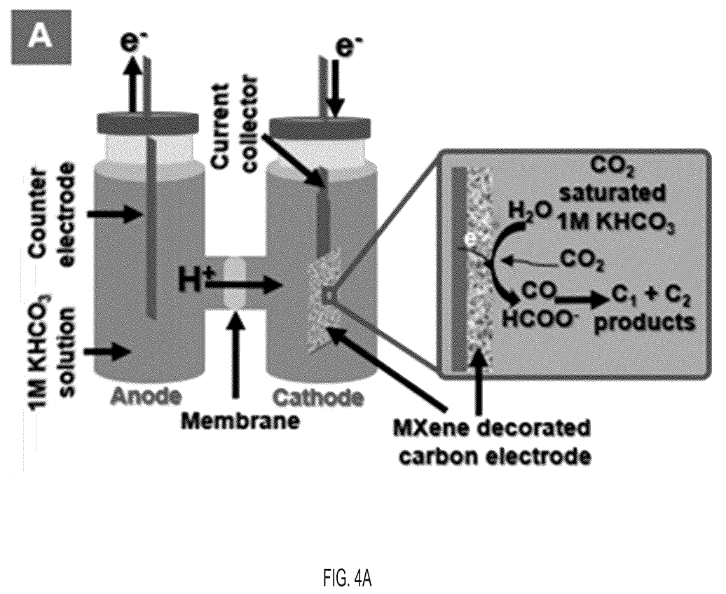

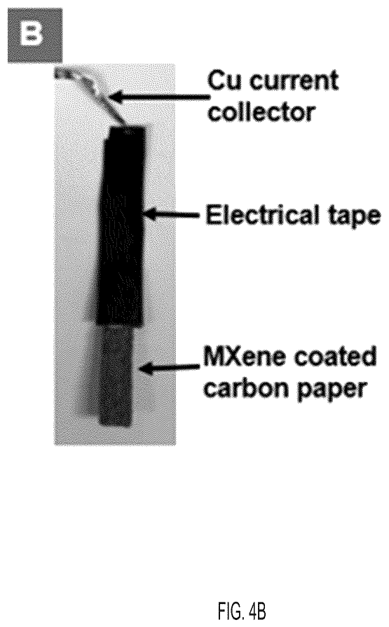

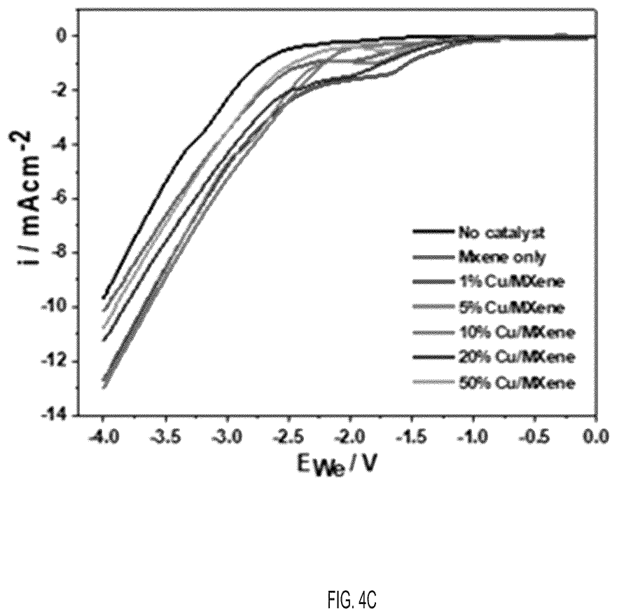

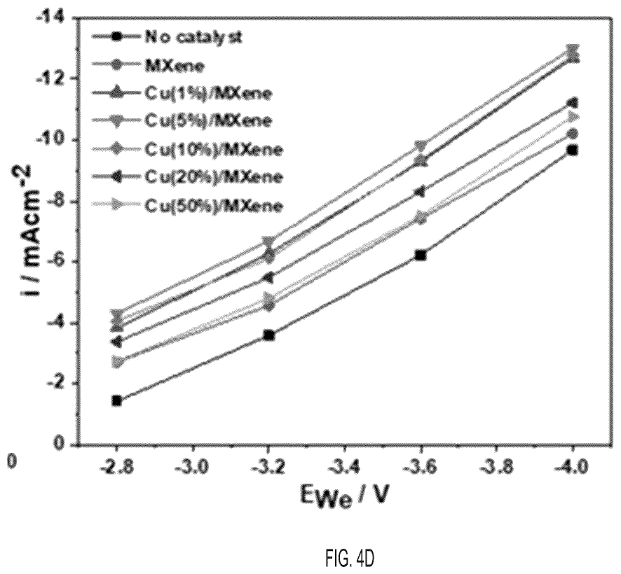

FIG. 4A illustrates a schematic diagram of an H-cell. An H-cell configuration can be used in the investigation of the electrocatalytic CO₂ reduction reaction. Within this system, the working electrode can be fabricated using Toray carbon paper (e.g., H-60) decorated with MXene. A Ni foil can be used as the counter electrode, as illustrated in FIG. 4A. The materials used can optimize the system's performance and ensure its stability. The Toray carbon paper can be 200 μm in thickness. This material can have a high surface area and excellent electrical conductivity, making it a good substrate for supporting catalysts such as MXenes.

The method for preparing the slurry for the working electrode can include uniformly dispersing MXene onto the carbon paper substrate, aided by a Teflon-based binder. This approach can optimally distribute the MXene, which, in turn, can promote efficient CO₂RR catalysis. The adoption of an H-cell configuration can prevent the oxidation of specific reaction products during the electrocatalytic process. This design not only offered a controlled environment but also can allow the electrochemical properties of MXenes to be effectively harnessed for targeted product formation and, subsequently, enhanced performance.

For introducing carbon dioxide into the system, a CO₂-saturated 1M KHCO₃ solution can be used as the catholyte, while 1M KHCO₃ can be used as the anolyte. These two solutions can be separated by a proton-conducting membrane, as shown in FIG. 4A. To create the working electrode, a slurry containing MXene and a Teflon binder can be coated (e.g., evenly coated) onto the carbon paper (200 μm thick). This process can result in a uniform thickness on both sides and allow for the uniformity of the working electrode (FIG. 4B). FIG. 4B illustrates a MXene-coated carbon electrode. The Teflon-based binder can be more effective in binding MXene to the carbon substrate than Nafion-based binders since Nafion-based binders can tend to leach MXene-based flakes under catalytic conditions.

The electrocatalytic activity of MXene-decorated electrodes in the context of CO₂RR can be assessed using linear sweep voltammetry (LSV). Varying copper loading can impact the current density. FIG. 4C illustrates the LSVs for different Cu-decorated MXene electrodes, all immersed in a CO₂-saturated KHCO₃ electrolyte. The electrochemical potential can be varied from 0 to −4.0 V with a scan rate of 20 mV/s. The current density for the Cu-decorated MXenes can surpass that of the pristine MXene. This can underscore the substantial influence of copper in the CO₂RR. The augmented current density in the presence of copper can be attributed to the facilitation of rapid electrochemical reactions, coupled with the swift mass transfer of reactants and products near the electrocatalyst's surface. The uniform distribution of copper across the MXene surface can contribute to the enhanced electron mobility, facilitating efficient electron transfer between the electrode and the electrocatalyst surface. The current densities can exhibit variation in response to the applied voltages. The highest current density can be observed within the voltage range of −2.8 V to −4.0 V. This specific voltage range can correspond to the region where the electrochemical process of CO₂ reduction predominantly dominates. In this voltage range, the electrocatalyst can exhibit its maximum catalytic activity, which can provide insights into the operating conditions where CO₂RR is most effective. Among the various Cu-loaded MXene electrodes investigated, the Cu(5%)/MXene sample displayed the highest current density within the voltage range of −2.8 V to −4.0 V, as depicted in FIG. 4D. This specific composition, Cu(5%)/MXene, can demonstrate superior electrocatalytic performance during CO₂ reduction. Consequently, the Cu(5%)/MXene sample can be selected as the prime candidate for an in-depth study of its electrocatalytic activity in the context of CO₂RR.

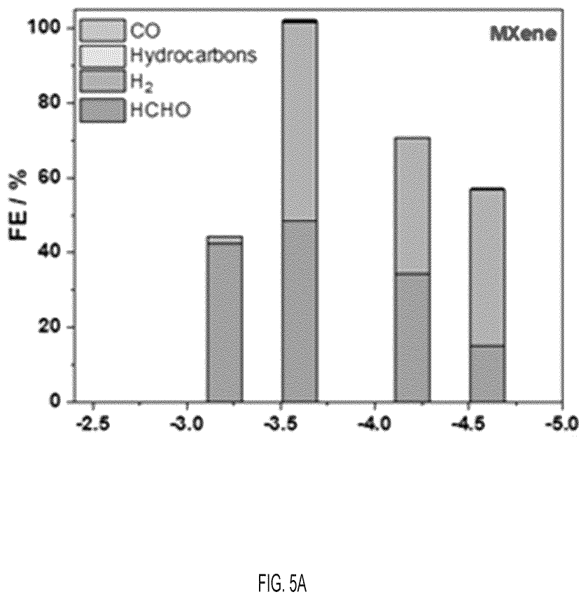

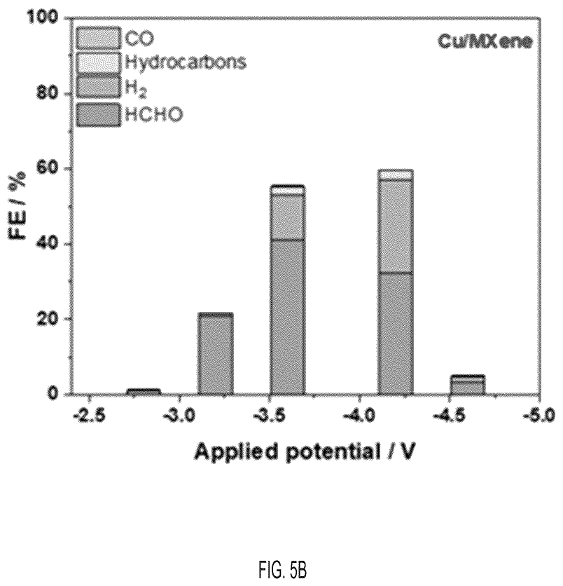

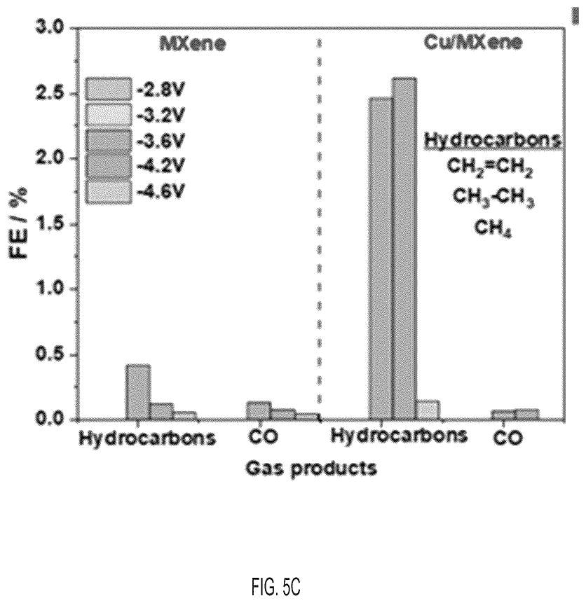

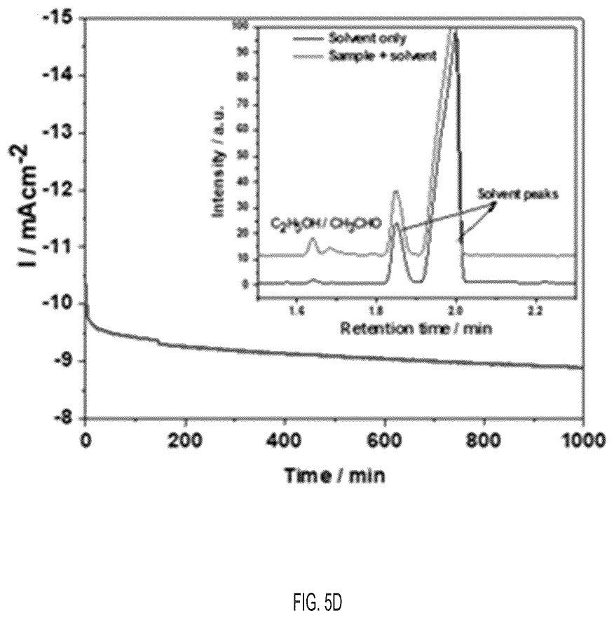

A quantitative assessment of the gaseous products evolving during the CO₂ reduction reaction (CO₂RR) can be performed using gas chromatography-mass spectrometry (GCMS). FIG. 5A illustrates the faradaic efficiency for different gas products for MXene electrodes. In FIG. 5A, the Faradaic efficiency (FE) of various gaseous products can be presented as a function of applied potential, ranging from −2.8 V to −4.0 V, for the MXene-modified electrode. Within this context, formaldehyde (HCHO) can be a major gaseous product during CO₂RR. Significant quantities of hydrogen can also be detected. The amounts of both H₂ and HCHO can peak at −3.6 V for the MXene-modified electrode, with a FE of 53.32% for H₂ and a FE of 48.40% for HCHO.

FIG. 5B illustrates the faradaic efficiency for different gas products for Cu(5%)/MXene modified electrode. When using the Cu (5%)/MXene-modified electrode, the HER can be suppressed (with a reduction of almost 60% observed at −3.6 V). Simultaneously, the Cu (5%)/MXene electrode can exhibit a FE of approximately 40.98% for HCHO at −3.6 V. Additionally, at −3.6 V and −4.2 V with the Cu (5%)/MXene electrocatalyst, small amounts of hydrocarbons can be detected.

FIG. 5C illustrates the faradaic efficiency of the different hydrocarbons observed as a function of applied potentials with MXene and Cu/MXene samples. These hydrocarbons can include methane, ethane, and ethylene. These quantities of hydrocarbons can be higher for Cu (5%)/MXene compared to pristine MXene, highlighting the effectiveness of copper in facilitating C—C coupling reactions during CO₂RR. The preferential formation of these hydrocarbons on Cu/MXene over bare MXene can be attributed to surface structural changes that occur during the formation of the heterostructure. These alterations in the surface chemistry can enhance the binding of intermediates, ultimately leading to the selective formation of hydrocarbons.

Chronoamperometric studies can be conducted by selecting a specific voltage (e.g., −3.6 V) and extending the study over an extended period. A chronoamperometric study, conducted at an applied potential of −3.6 V for 1000 minutes, can reveal remarkable stability in both current density and potential, as illustrated in FIG. 5D. FIG. 5D illustrates current density vs. time during chronoamperometric electrolysis at −3.6 V. During this testing period, there were no observable signs of delamination of the electrocatalyst, attesting to its robust structural integrity. Moreover, a thorough examination of the electrode modified with the Cu(5%)/MXene catalyst, following the rigorous 1000-minute run, can demonstrate an intact morphology. This finding further underscores the exceptional stability of the Cu/MXene electrocatalyst under demanding electrochemical conditions. Throughout the 1000-minute CO₂RR experiment, the capacity was determined to be 49.95 mAh.

In addition to these electrochemical assessments, liquid samples post-1000-minute chronoamperometric study can be collected. The liquid samples can be subjected to GCMS analysis. The GC chromatograph of the liquid sample derived from the Cu/MXene CO₂RR run can reveal the presence of small quantities of ethanol and/or acetaldehyde, as indicated in the inset figure in FIG. 5D. The inset shows GCMS results for liquid injection showing the C₂ products. These findings can be further corroborated by comparison with standard samples, confirming the occurrence of these specific products during the CO₂RR process. The emergence of C₂ products such as ethanol and acetaldehyde within the Cu(5%)/MXene catalyst during the CO₂RR can be ascribed to the distinctive interaction of *CO/*COOH intermediates on the surface of Cu nanoparticles. The surface of Cu nanoparticles in the Cu(5%)/MXene electrocatalyst can provide an ideal environment for the adsorption and interaction of *CO and *COOH species. These intermediates, which are found in the CO₂RR mechanism, can be stabilized and effectively facilitated in their transformation into C₂ products. The unique properties of Cu nanoparticles, in conjunction with the supportive structure of MXene, can promote the formation of C—C bonds, leading to the preferential generation of C₂ products (ethanol and acetaldehyde).

There has been a significant surge in research efforts dedicated to the electrochemical conversion of carbon dioxide into diverse carbonaceous products. The success of CO₂ electroreduction can hinge on the complex interplay of various factors, including reaction conditions and the choice of electrocatalysts. These multifaceted variables can play a pivotal role in governing the number of electrons involved in CO₂RR, and subsequently dictate the final product spectrum. Potential products stemming from CO₂RR can include carbon monoxide, formic acid, methanol, methane, ethylene, ethanol, propanol, acetaldehyde, and formaldehyde.

The preferential formation of formaldehyde, involving a 4-electron chemistry, with a Faradaic Efficiency (FE) of 48.40% when using pristine Ti₃C₂Tₓ MXene, can be observed. However, the product selectivity can undergo significant transformations when employing metal-modified, particularly copper-modified, titanium-based MXene electrocatalysts. The introduction of copper, in various forms including single atoms, doping, or heterostructures, can significantly influences the FE of different products. Beyond the realm of MXene-based electrocatalysts, the nature of the final CO₂RR product can depend on the type of copper metal used. For example, the use of single-atom copper electrocatalysts can predominantly yield ethanol, a product formed through a 12-electron process, with an FE exceeding 90%. In contrast, polycrystalline copper achieves an FE of only 21.9%. Sputtered copper, operating via 8-electron chemistry can primarily produce methane (CH₄) as a major product during CO₂RR, with an FE of approximately 50%. Furthermore, the choice of copper in different forms, such as nanoparticles, nanocubes, or face-oriented structures, can exhibit a preference for the formation of ethylene or ethanol by engaging 12 electrons during CO₂RR. These findings highlight the remarkable versatility and tunability of electrocatalytic systems for CO₂RR, offering a spectrum of potential solutions in the pursuit of sustainable and efficient CO₂ conversion technologies.

A redox-mediated wet chemistry approach for the fabrication of a Cu/MXene heterostructure electrocatalyst is described, including its application in CO₂ electroreduction. The method can include the reductive adsorption of copper on the MXene surface, which is intricately linked to the simultaneous self-oxidation of titanium during the synthesis process. A range of advanced characterization techniques can be performed to propose a comprehensive mechanism underlying the reductive adsorption of copper onto the MXene substrate. This approach can take advantage of the MXene structure's surface chemistry, which can provide a platform for the efficient adsorption of metal ions. This adsorption event can trigger a cascade of reactions, including the oxidation of titanium centers, leading to changes in bonding configurations and the generation of Ti—O, and TiO₂ species. The reductive adsorption of copper onto the Ti₃C₂Tₓ MXene not only effectively immobilized metallic copper on the MXene surface but also induced notable improvements in its electrochemical performance.

The electrochemical performance of various Cu-loaded MXenes can surpass that of pristine Ti₃C₂Tₓ MXene-modified carbon electrodes. Formaldehyde can be the primary gaseous product of CO₂ electroreduction, achieving a remarkable Faradaic efficiency exceeding 40.98% at an operating potential of −3.6V when utilizing a Cu(5%)/MXene heterostructure electrocatalyst. An extensive 1000-minute runtime at this voltage can reveal the detection of C₂ products, including ethanol and acetaldehyde, in the reaction mixture. These findings underscore the promise of the Cu/MXene heterostructure as a versatile and efficient electrocatalyst for CO₂ electroreduction, offering valuable insights into the electrochemical transformation of CO₂ into valuable chemical products, with the potential to address pressing environmental challenges and advance sustainable energy technologies.

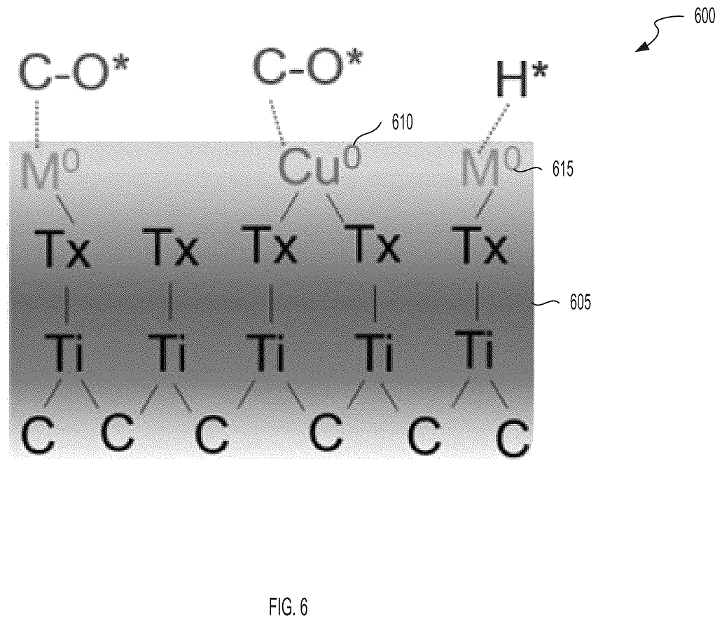

FIG. 6 illustrates a MXene/metal heterostructure. The MXene/metal heterostructure can include a material 600. The material 600 can include a MXene 605. A structure of the MXene can be selected from M₂Tₓ, M₃X₂Tₓ, M₄X₃Tₓ, and M₅X₄Tₓ, wherein M includes at least one transition metal, X is selected from carbon and nitrogen, and Tₓ is a surface termination. The surface termination can include a surface termination group. For example, the surface termination group can include —O, —OH, —F, —Cl, etc. The at least one transition metal can be selected from scandium, titanium, vanadium, chromium, yttrium, zirconium, niobium, molybdenum, hafnium, tantalum, and tungsten. The at least one transition metal can be oxidized. The material 600 can include a MXene/metal heterostructure. For example, the material 600 can include a MXene/CuM heterostructure. The material 600 can include a metal-adsorbed MXene.

A first metal 610 can be adsorbed on the MXene 605. The first metal comprises 610 can include copper. A second metal 615 can be adsorbed on the MXene 605. The second metal 615 can be different from the first metal 610. The second metal 615 can be selected from silver, tin, zinc, ruthenium, iron, nickel, gold, platinum, iridium, palladium, rhodium, cobalt, and osmium. At least one of the first metal 610 or the second metal 615 can be adsorbed on the MXene 605 at defect sites. For example, at least one of the first metal 610 or the second metal 615 can be adsorbed on the MXene 605 at defect sites using a reductive adsorption approach. The first metal 610 or the second metal 615 can be adsorbed on the MXene 605 as closely packed nanoparticles or single atoms.

The material 600 can be configured to perform carbon dioxide reduction. The material 600 can be configured to produce at least one of formaldehyde, formic acid, methanol, ethanol, carbon monoxide, formic acid, methane, ethylene, propanol, or acetaldehyde. CO* and H* intermediates can bind onto the metal-adsorbed MXene. Weak H* and CO* binding affinity can result in fewer and non-fully reduced products such as alcohols. Strong H* and CO* binding affinity can lead to fewer and fully reduced products/hydrocarbons.

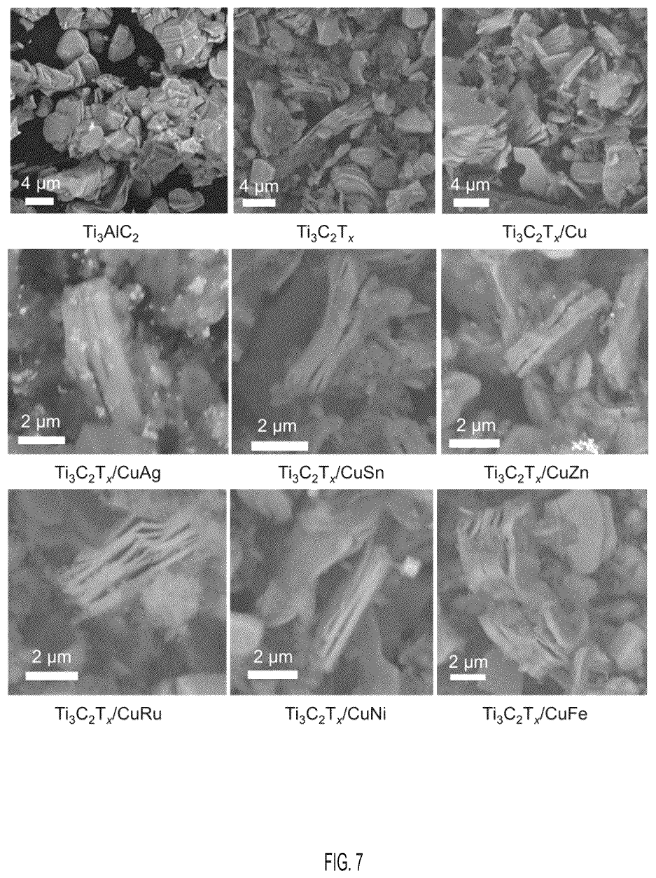

FIG. 7 illustrates SEM images for the MAX phase, pristine MXene, and MXene heterostructures. The MAX phase includes Ti₃AlC₂. The pristine MXene includes Ti₃C₂Tₓ. The MXene heterostructures include Ti₃C₂Tₓ/Cu and Ti₃C₂Tₓ/CuM. Ti₃C₂Tₓ/CuM includes Ti₃C₂Tₓ/CuAg, Ti₃C₂Tₓ/CuSn, Ti₃C₂Tₓ/CuZn, Ti₃C₂Tₓ/CuRu, Ti₃C₂Tₓ/CuNi, and Ti₃C₂Tₓ/CuFe.

A method of the present disclosure can include mixing one or more metal salts in solution and a dispersion of a native MXene to form a functionalized MXene mixture. The functionalized MXene mixture can include the first metal 610 and the second metal 615. The first metal 610 and the second metal 615 can be adsorbed on the native MXene. The method can include filtering the functionalized MXene mixture to form a filtered functionalized MXene mixture. The method can include drying the filtered functionalized MXene mixture to form a functionalized MXene solid. The method can include drying the filtered functionalized MXene mixture to form a functionalized MXene material. The method can include drying the filtered functionalized MXene mixture to form a functionalized MXene powder. The functionalized MXene solid can include metal adsorbed on the MXene.

One or more atoms of at least one of the first metal 610 or the second metal 615 can be disposed on at least one of a basal plane of the native MXene or one or more edge sites of the native MXene. The native MXene can be formed via etching of a MAX phase with a mild approach using HCl and LiF. The one or more metal salts in solution can include a copper nitrate solution.

The method can include increasing a concentration of defects of the native MXene via etching or sonication. The method can include performing carbon dioxide reduction with the functionalized MXene solid. Mixing the one or more metal salts in solution and the dispersion of the native MXene can occur at room temperature.

### III. Overview of Systems and Methods for MXene Heterostructures

The development of effective catalysts for the electrochemical CO₂ reduction reaction (CO₂RR) can be needed to maximize the value reaped from this feedstock. The systems and methods of the present disclosure are directed to a class of CO₂RR electrocatalysts that include hybrids of Cu-based alloys and Ti₃C₂Tₓ MXene. These Ti₃C₂Tₓ/CuM heterostructures can be formed through electroless adsorption of the alloys onto the surface of the MXene by oxidizing the Ti moieties of the MXene. The reduction potential of the adsorbed metals dictated this process with the strongly oxidizing metals reaching their lowest oxidation states while the weakly oxidizing metals were only partially reduced. When applied to CO₂RR, these Ti₃C₂Tₓ/CuM heterostructures can selectively generate formaldehyde. Furthermore, formaldehyde can be most efficiently generated at low and industrially relevant cell potentials, −1.4 V to −2.2 V. The implications of these results as it pertains to their impact on CO₂RR mechanistic pathways and potential for industry adoption are described herein.

The synthesis was carried out in two steps as illustrated in FIG. 8A. FIG. 8A illustrates a synthesis procedure entailing selective etching of the MAX phase and reductive adsorption of the metals onto Ti₃C₂Tₓ. The first step can include the preparation of the Ti₃C₂Tₓ MXene through selectively etching the Ti₃AlC₂ MAX phase with in situ generated HF, in mixed solutions of HCl and LiF. In the second step, MXene/CuM heterostructures can be produced by mixing dispersions of the MXene with salt solutions of Cu and the secondary metals (M). Any combination of secondary metals (including Cu, Ag, Sn, Zn, Ru, Ni, Fe, Rh, Pd, Pt, Au, Os, Ir, and In) can be selected based on their *CO and *H binding affinity. Morphologies typical for MAX phase and MXenes structures can be observed with scanning electron microscopy (SEM).

FIG. 8B illustrates PXRD patterns of the MAX phase, pristine MXene, and MXene heterostructures. Powder x-ray diffractions (PXRD) shown in FIG. 8B can indicate that the desired Ti₃AlC₂ MAX phase and Ti₃C₂Tₓ MXene were obtained. For the Ti₃C₂Tₓ/CuM samples, no x-ray diffraction peaks of the adsorbed metals were observed, except for Ag. This can indicate that only small quantities of the metals were anchored onto the MXene and that they were well dispersed. The deviating behavior of Ag can be in line with its high oxidizing potential as illustrated in FIG. 8F. The standard reduction potential of Ag is more than double that of Cu, the second metal on the list. PXRD also shows that the basal plane peaks (002) at 2⊖ between 6.5° and 7.3° were less intense and shifted to lower 2⊖ values for Ti₃C₂Tₓ/CuM heterostructures than their parent Ti₃C₂Tₓ. This behavior can indicate that adsorbing the metals expanded the interlayer spacing of the MXenes and most likely further exfoliated them. There is also a possibility that the less intense (002) PXRD peaks indicate the destruction of the MXene structures. However, this possibility is less likely since only minor oxide and carbide impurity peaks were observed across all MXene/CuM heterostructures. Had the MXene structure been severely compromised, significant amounts of impurity phases would have been observed. Instead, the observed TiOₓ and TiCₓ phases resulted from oxidation of the Ti moieties of the MXenes upon donating electrons to the adsorbed metals.

High magnification scanning transmission electron microscopy (STEM) can confirm the successful adsorption of the metals. The energy dispersive x-ray spectroscopy (EDS) maps of the Ti₃C₂Tₓ/CuM samples clearly show the presence of the MXene elements (Ti and C) as well as the adsorbed metals (Cu and M) covering the same areas (FIG. 8C). FIG. 8C illustrates high magnification STEM and EDS of the MXene heterostructures. For the most part, the metals can be adsorbed in discrete units, reminiscent of single atoms. In some cases, especially for Cu, the units can be closely packed, indicating possibility of nanoparticle formation. Weak coverages can be observed for Ni and Fe, most likely a result of unfavorable redox dynamics and/or slow kinetics due to their low oxidizing potentials (FIG. 8F). Low magnification STEM and EDS data indicated agglomeration of Ag deposits, but not for other metals. This trend can agree with PXRD results as they both point to Ag being deposited onto Ti₃C₂Tₓ in larger quantities than other metals, further confirming that oxidizing potential dictates the adsorption extent of these metals.

X-ray photoelectron spectroscopy (XPS) data shown in FIGS. 8D and 8E can highlight the influence of oxidizing potential on oxidation state of the adsorbed metals. FIG. 8D illustrates a Cu 2p XPS spectra of the MXene heterostructures. As indicated by Cu2p spectra (FIG. 8D), Cu can be adsorbed in its metallic form across all samples. This observation can be in line with the high oxidizing potential of Cu with respect to Ti (FIG. 8F) which enabled the former to draw enough electrons from the MXene core and reach its metallic form. FIG. 8E illustrates characteristic metal (M) XPS spectra of the MXene heterostructures. Furthermore, as shown in FIG. 8E, the same trend can be observed with the secondary metals: those with higher oxidizing potentials than Ti can be adsorbed in their metallic forms (Ag, Ru), those with values closer to Ti can be adsorbed as mixtures of their oxidized and metallic forms (Sn, Ni), while those with lower values can be predominantly adsorbed in their oxidized forms (Fe and Zn). In the case of Zn, the Zn 2p spectra of Zn metal and ZnO overlap which made it complicated to discern which form had been adsorbed. However, XPS peaks with kinetic energies corresponding to LMM Auger lines of both species can be observed in the general XPS survey, indicating that a mixture of both was adsorbed. Furthermore, the ZnO peaks had more intensity than Zn⁰, implying that ZnO was the predominant form. The same trends can be observed with the Ti₃C₂Tₓ/M heterostructures that only included one metal, indicating that the Cu and M adsorptions in Ti₃C₂Tₓ/CuM heterostructures were not co-dependent. Furthermore, high signal to noise ratios can be observed for metals with low oxidizing potentials, including Ni and Fe in agreement with STEM/EDS data.

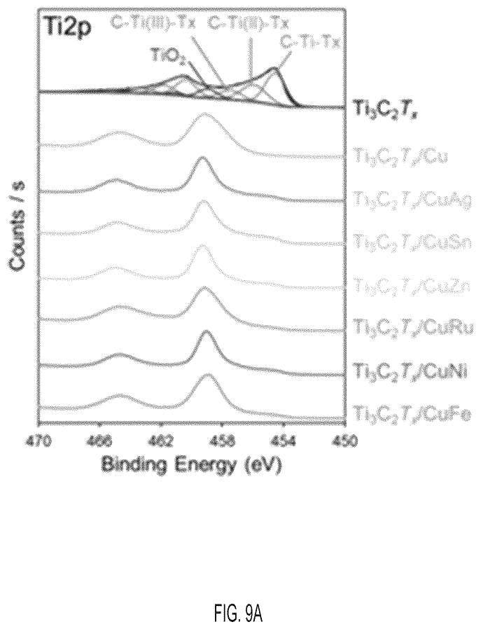

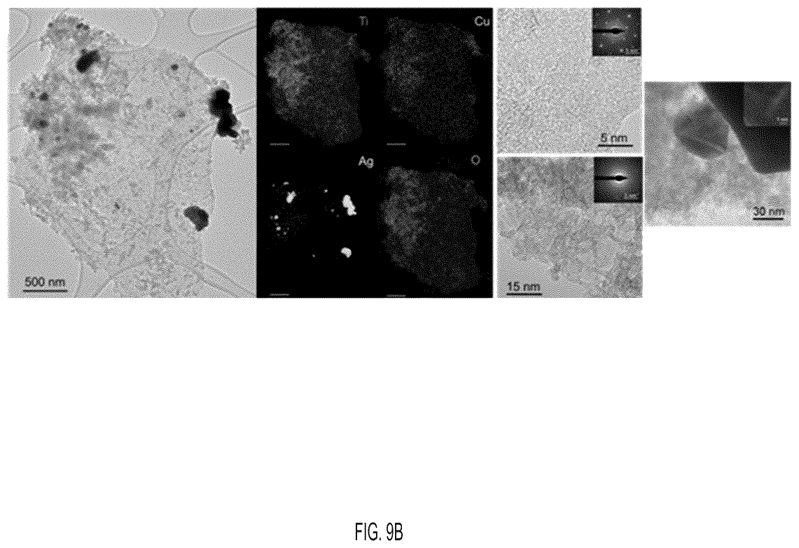

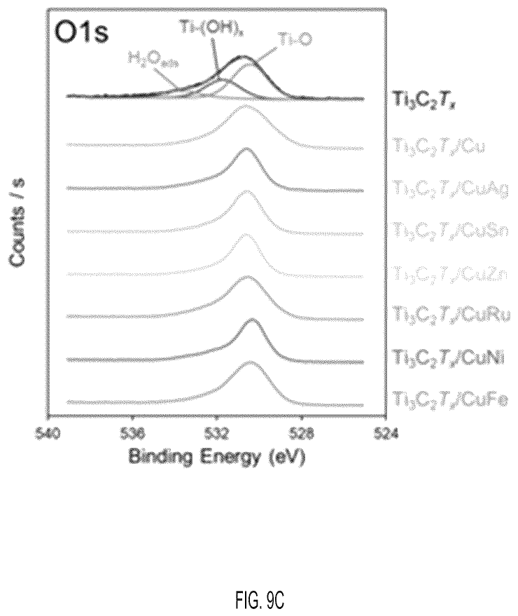

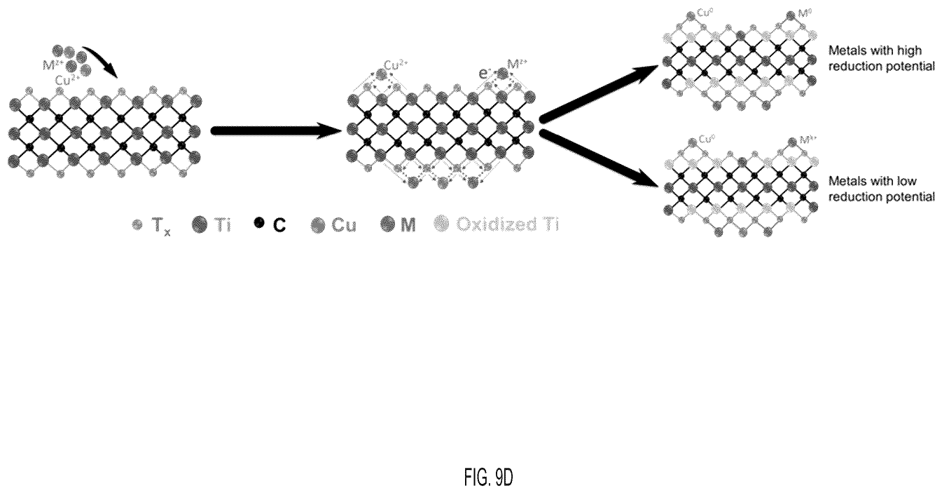

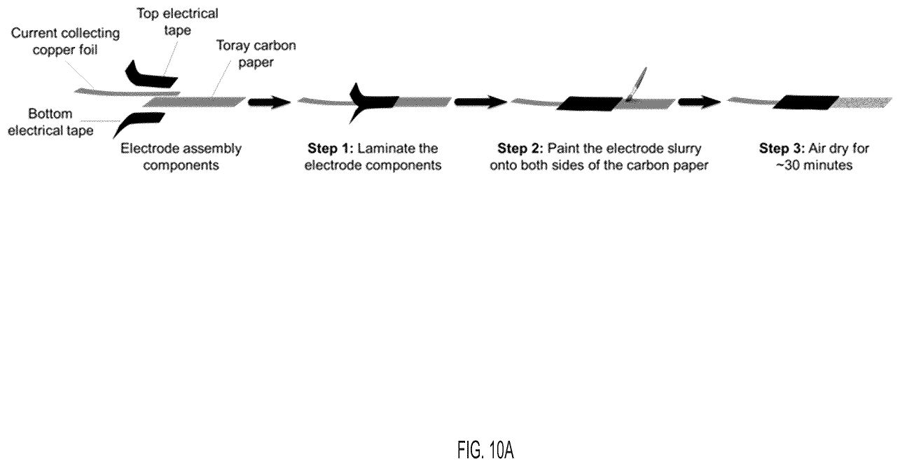

The Ti 2p XPS spectra of the Ti₃C₂Tₓ parent MXene and its modified heterostructures (FIG. 9A) further illustrates the correlation between metal adsorption and oxidation of the MXene Ti core. FIG. 9A illustrates a Ti 2p XPS spectra of the pristine MXene and MXene heterostructures. As shown in the figure, the TiO₂ peak, representing the highest Ti oxidation state (+4), can be significantly more intense in the MXene heterostructures than the pristine MXene. This is further supported by the High-Angle Annular Dark-Field (HAADF) STEM data shown in FIG. 9B. FIG. 9B illustrates a HAADF STEM image, EDS, and electron diffraction of Ti₃C₂Tₓ/CuAg. As the figure shows, the contrast partitions the flake in three zones: large discrete dark particles, a dark grey zone, and a light grey zone. Such differences in contrast can imply the presence of multiple surface species. EDS mapping can indicate the large dark particles to be agglomerated Ag, the dark grey zone to represent oxidized portions of the MXene as illustrated by the correlation between the Ti and O EDS signals, and the light grey zone to represent the pristine MXene portion. Furthermore, the electron diffraction data can agree with this interpretation as hexagonal pattern, characteristic of MXene, were observed in the light grey zone while rings, indicative of oxidation and small polycrystals, were observed in the dark grey zone (FIG. 9B).

Upon establishing how the metals were adsorbed onto the MXene, where they were anchored can then be investigated. Density function theory (DFT) can be used to determine the most energetically favored anchoring sites for metals onto the MXene. First, a special quasi-random structure (SQS) of pristine Ti₃C₂Tₓ can be generated with Tₓ groups that include 80% —OH and 20% —F. This termination composition can be determined by XPS to be representative of all the studied Ti₃C₂Tₓ/CuM heterostructures. Then, DFT calculations can be conducted to determine the energy associated with anchoring Cu to the surface of the MXene onto Tₓ groups versus inside its core as Ti substitutes. The O 1s spectra shown in FIG. 9C, further support the surface adsorption preference as the Ti—(OH)ₓ peak intensity decreased for all heterostructures with respect to the pristine MXene. This behavior can indicate that the —OH termination groups were involved in the metal adsorption process and most likely altered through that process. FIG. 9C illustrates an O 1s XPS spectra of the pristine MXene and MXene heterostructures.

Putting together all the above-described information, a mechanism can be proposed for adsorbing metals onto Ti₃C₂Tₓ (FIG. 9D). FIG. 9D illustrates a mechanism for reductive adsorption of Cu and secondary metals (M) onto Ti₃C₂Tₓ. Upon mixing the MXene dispersions with the metal salt solutions, the cations can be attracted to the negatively charged surface termination groups. The termination groups can then donate electrons to the adsorbed cations to form Tₓ-M bonds, which can then trigger the movement of electrons from adjacent Ti elements, raising their oxidation states. Metals with high oxidizing potential can command enough electrons from the MXene core to be reduced to their metallic forms while metals with low oxidizing potential can only draw so many electrons to be partially reduced.

In many cases, impurity phases such as TiOₓ, TiCₓ, and amorphous carbon can be observed (FIG. 8B) and can be attributed to local deterioration of the MXene structures. Such a deterioration can take place because of local large accumulations of adsorbing cations which draw excessive amounts of electrons not only from adjacent Ti, but also carbon moieties, leading to TiOₓ, TiCₓ, and amorphous carbon phases breaking away from the MXene crystal lattice. The vacancies left behind can then become additional anchoring sites as well as charge carriers, intensifying the oxidation process. Ti₃C₂Tₓ oxidation mechanisms involving formation of breakaway TiO₂ nanoparticles and accentuation of the process by Ti vacancies have been previously reported. Hence, it is logical to expect a critical adsorbed metal concentration beyond which the MXene structure will start to break down. In all the present cases, however, only minor TiOₓ and TiCₓ phases were observed with PXRD (FIG. 8B), indicating that the adsorbed metals were below or only slightly above this critical concentration.

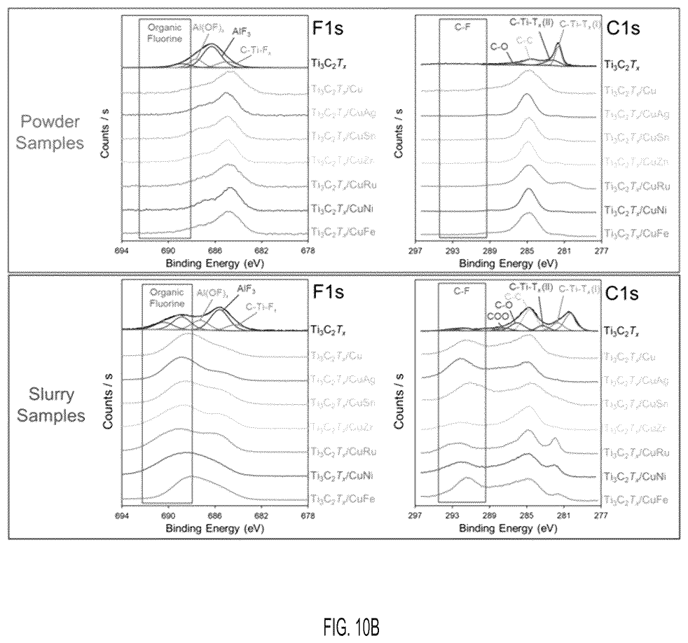

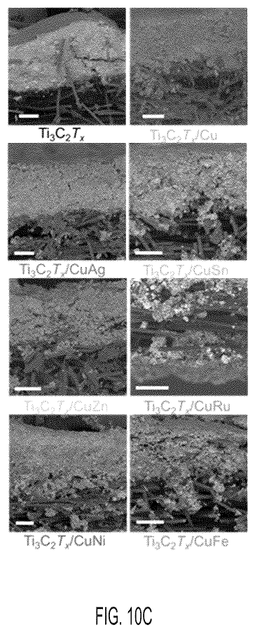

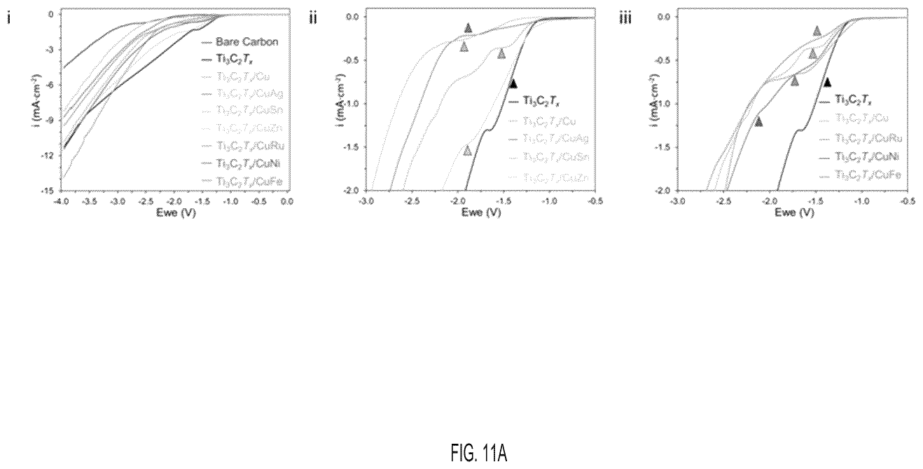

Each tested electrode can include a carbon paper substrate, a Cu current collector, and a MXene-based electrocatalyst printed onto the carbon substrate. The assembly procedure involved 3 steps as illustrated in FIG. 10A. First, the carbon substrate and the Cu current collector can be laminated using electrical tapes, ensuring that the two components were strongly connected and that no part of the Cu foil would be exposed to the electrolyte. In the second step, an electrode slurry including a mixture of MXene powder and Teflon emulsion binder can be applied onto the carbon substrate. Teflon emulsion can be chosen as the binding material due to its superior adhesion properties that mitigated electrode delamination as opposed to Nafion, the traditionally used binder. In the final step, the fabricated electrodes can be air dried at room temperature for 30 minutes.

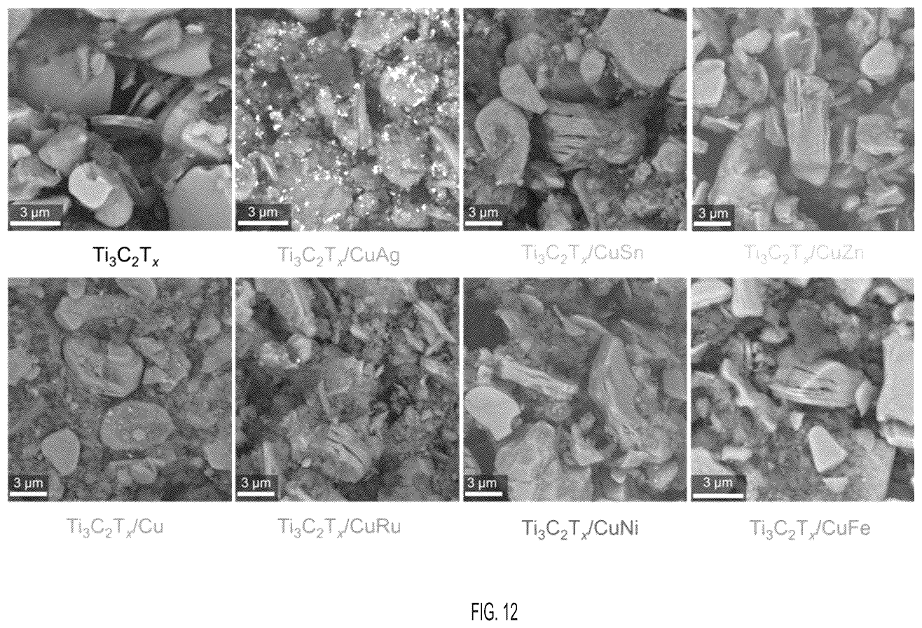

Similar to powder samples, the layered morphology typical for MXenes can be observed in slurries of the studied electrodes (FIG. 12). Furthermore, adsorbed metal species can be detected with XPS in the same oxidation states as powder samples. These two data sets can indicate that the MXene structures were preserved in high concentrations during processing of the electrode slurries, implying that enough active materials were available to drive CO₂RR. In addition to the MXenes, it can be confirmed that the electrode slurries also have the used Teflon emulsion binders as illustrated with XPS F 1s and C 1s spectra shown in FIG. 10B. FIG. 10B illustrates F 1s and C 1s XPS spectra of MXene powder (top box) and slurry (bottom box) samples. In FIG. 10B, F 1s and C 1s XPS spectra of the MXene powders can be compared to their slurry counterparts and the slurry samples can have additional peaks in regions associated with fluorine-containing species. To confirm that these fluorine peaks originated from the added Teflon emulsion binders, XPS can be conducted on a Teflon emulsion sample. The same peaks can be observed in its F 1s and C 1s spectra.

Upon establishing that the electrode slurries included both the MXenes and the binding material, cross-sections of the assembled electrodes can be imaged with SEM to assess the efficacy of depositing the electrode slurries onto the carbon substrates (FIG. 8C). FIG. 8C illustrates SEM cross-sectional images of MXene electrodes. The scale bars are 50 μm. As shown in FIG. 8C, the deposited layers can be thick (e.g., ˜100-150 μm), coherent, and well-adhered to the carbon fibers of the substrates. At the interface, the carbon fibers can cross through the electrode layers, reminiscent of steel reinforced concrete. Such a strong adhesion of the electrocatalysts to the substrates can be the reason behind the observed robustness of these electrodes.

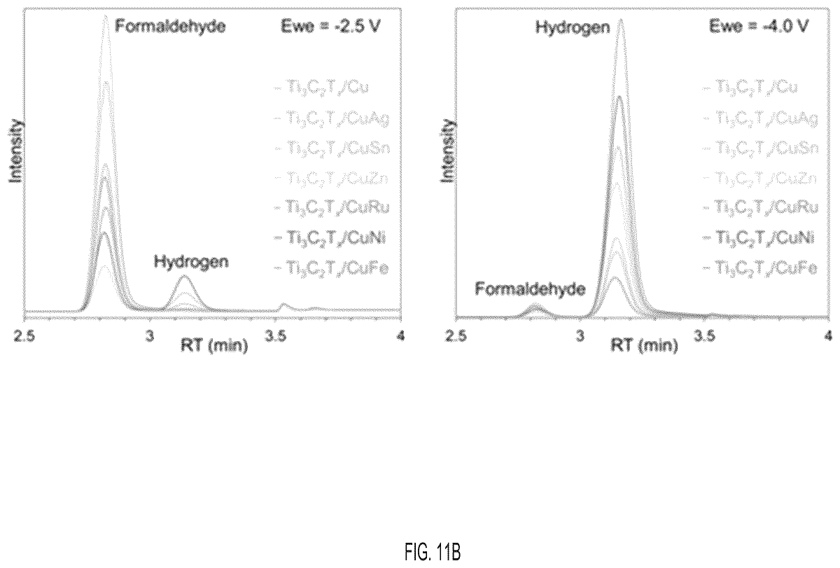

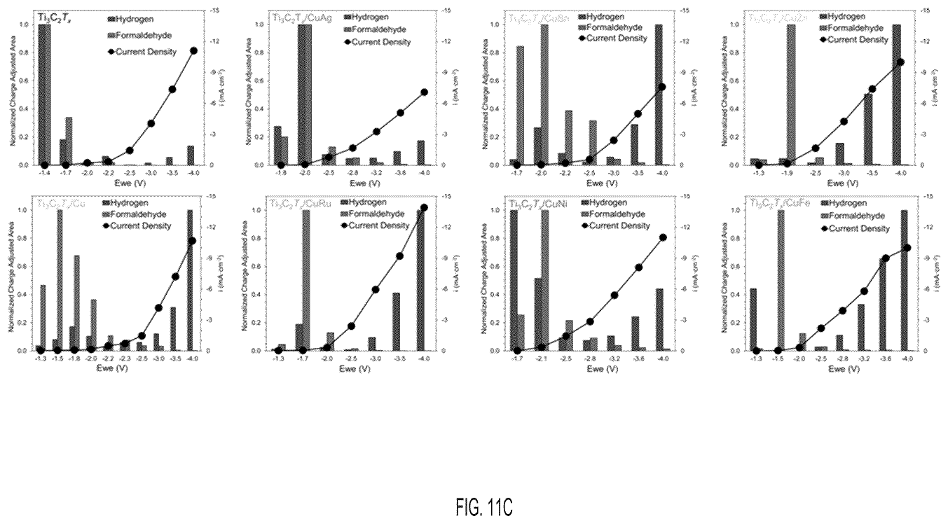

The electrocatalytic CO₂ reduction reactions can be conducted using an H-type cell. The electrochemical performances can be evaluated with linear sweep voltammetry (LSV) and chronoamperometry (CA). The same 1M KHCO₃ solution can be used as both the catholyte and anolyte with Nafion as the separating membrane. For LSV, the cell potential can be varied between 0 and −4 V at a 20 mV·s⁻¹ rate. Higher current densities and lower onset potentials can be achieved for all the MXene samples with respect to the bare carbon substrate (FIG. 11A-i), indicating that the MXene electrodes were promoting electrocatalytic processes. Peaks/plateaus can be observed for all tested electrodes between −1.4 and −2.1 V (FIG. 11A-ii & iii). FIGS. 11A-ii and 11A-iii are zoomed in views of FIG. 11A-i. For the Ti₃C₂Tₓ/Cu electrode, two additional peaks can be observed at −2.0 and −2.3 V. These LSV peaks can correspond to points of high CO₂RR efficiency for each electrode. As such, the presence of multiple peaks for Ti₃C₂Tₓ/Cu can be indicative of multiple favored electrocatalytic processes, which were narrowed with the use of bimetals and/or alloys.

As indicated by gas chromatography (GC), across all electrocatalysts and cell potentials, two gas products can be observed: formaldehyde and hydrogen and no liquid products were detected. Formaldehyde can be preferentially produced at low cell potentials while hydrogen can be the dominant product at high potentials (FIGS. 11B and 11C). Due to the low concentration of the available formaldehyde gas standard, its generation by this process can be further confirmed by vapors from a heated formaldehyde solution. The GC peak position of the formaldehyde vapors can align with the standard as well as a CO₂RR product peak. While the use of formaldehyde vapors or low concentration standard can be effective for qualitative confirmation of formaldehyde generation by the system, it may not be reliable for quantitative determination of formaldehyde partial charges. Hence, instead of the typical faradaic efficiency (FE, equation 2), GC peak areas can be normalized by total charge (equation 3) to assess efficiency. This measure of efficiency can be termed: “charge-adjusted area.” The trends of this measure can mirror those of the FE as is exemplified when both measures are compared for hydrogen. Hence, “charge-adjusted area” can be used to determine cell potentials that would correspond to the highest faradaic efficiencies of the CO₂RR products (FIG. 11C).

The highest charge-adjusted areas (CAA) can be observed at cell potentials between −1.4 and −2.1 V for formaldehyde (FIG. 11C). This can imply that the MXene electrocatalysts produced formaldehyde most efficiently at low cell potentials. The high efficiency cell potentials can correspond to the LSV plateaus indicated in FIGS. 11A-ii and 11A-iii. Furthermore, the CAA values can be significantly lower outside of the peak potential. These observations together can indicate that formaldehyde generation was favored at specific low cell potentials. For Ti₃C₂Tₓ/Cu, the formaldehyde CAA was not substantially lower at cell potentials near the peak, unlike other heterostructures. This could be indicative of multiple active zones for formaldehyde generation and in line with its LSV spectrum that had multiple peaks.

For hydrogen generation, the CAA can be highest at extreme cell potentials. H₂ can be generated from two processes: proton reduction at lower (least negative) potentials and water splitting at higher (most negative) potentials. As such the H₂ CAA can be lowest at mid potentials where the formaldehyde CAA was highest, indicating that the MXene electrocatalysts hold high potential to selectively produce formaldehyde. The cases of Ti₃C₂Tₓ and Ti₃C₂Tₓ/CuAg were the exceptions to this trend as the highest CAA for both H₂ and formaldehyde were observed at the same cell potentials. One possible reason for this behavior could be that these electrocatalysts adsorbed formaldehyde and hydrogen intermediates differently from other heterostructures perhaps because Ti₃C₂Tₓ had no CuM species to accentuate the adsorption of key intermediates while the agglomeration of Ag in Ti₃C₂Tₓ/CuAg may have altered its H₂ evolution electrocatalytic properties.

The systems and methods of the present disclosure can include formaldehyde generation from CO₂RR. MXene catalysts can generate 2 and 6 electrons products. Furthermore, the 6 electrons product (CH₃OH) can be generated by MXenes modified with Cu, which can show that modified MXenes can achieve reduction depths beyond 2 electrons.

Direct electrochemical CO₂RR does not typically produce formaldehyde. In this respect, given that formaldehyde can be generated in the study, it is most likely that the Ti₃C₂Tₓ modifications with CuM changed the energy dynamics associated with certain steps of that pathway. Specifically, the energy associated with the generation, reduction, and/or desorption of the formaldehyde level intermediate (*CH₂O) was likely altered in a way that favored the generation of formaldehyde. In typical CO₂RR pathways, the reduction of *CH₂O is energetically favorable, which is why formaldehyde is normally not achieved through direct CO₂RR. Thus, it is possible that the Ti₃C₂Tₓ/CuM heterostructures reversed this trend by increasing the *CH₂O reduction energy, rendering it unfavorable to produce *CH₃O, the intermediate for methanol. The other possibility could be that the *CH₂O desorption energy was substantially lowered on the Ti₃C₂Tₓ/CuM catalysts that it was removed from their surfaces before being further reduced to *CH₃O.

There is substantial value in producing formaldehyde through CO₂RR, especially to the manufacturing industry. Formaldehyde is an ingredient in the industrial production of hundreds of products across many industries, including automotive, agriculture, construction, aerospace, and medicine. Upon optimization, the herein disclosed electrochemical process would be a simpler, greener, and more energy efficient alternative to the Formox process, the current state-of-the-art large-scale formaldehyde production method. The drawback of the Formox process is its high-cost intensiveness due to its reliance on three high-energy steps: 1) steam reforming of natural gas at 700° C.-1100° C., 2) methanol synthesis from the resulting syngas at 200° C.-300° C., and 3) partial oxidation as well as dehydrogenation of the methanol to produce formaldehyde at 300° C.-400° C. The industrialization of the herein disclosed electrochemical process would be much simpler and less energy intensive as it can proceed in one step at room temperature.

Industrial CO₂ reduction electrolyzers may need to meet three benchmarks for economically viable operations: 1) high selectivity, 2) low cell potential (<|2.5| V), and 3) high current density (>100 mA·cm⁻¹). The MXene heterostructures disclosed herein can meet two of the three benchmarks as the formaldehyde generation can be observed to selectively take place at specific low cell potentials (<|2.2| V). Hence, current density is the one figure of merit that could be improved. One approach to achieving such an improvement is optimizing mass transport throughout the electrolysis cell, a limitation associated with H-type cell reactors. H-type cells operate under stagnant electrolytes and, as a result, the CO₂ reduction reactants and products do not effectively diffuse to and from the electrocatalysts, resulting in low CO₂ conversion rates (current densities). This challenge can be circumvented with the use of flow cells whose continuous flow of the electrolyte improves the delivery of the CO₂ gas to the electrocatalyst as well as the evacuation of the products off of the catalysts. Indeed, reaction-diffusion models have predicted flow cells with gas diffusion layers to extend the CO₂ depletion current density by a factor of more than 10 with respect to H-type cells.

The following materials can be used to prepare the Ti₃AlC₂ MAX phase: Ti (325 mesh, 99.5%, Beantown Chemical), Al (325 mesh, 99.5%, Beantown Chemical), and TiC (99.5%, Beantown Chemical). Stoichiometric amounts of the three powders can be ball milled (Spex SamplePrep, 5120 Mixer/Miller) at 3500 rpm for 5 mins using zirconia beads with a 1:2 powder to bead weight ratio. The resulting blends can be pressed into pellets, transferred into alumina crucibles, and sintered at ≥1380° C. for 5 h under flowing Ar. The temperature ramp can be 10° C./min and 5° C./min below and above 1000° C., respectively. The furnace can be flushed with Ar for 15 mins before starting the heating program. Upon completion of the sintering schedule, the surface of the Ti₃AlC₂ pellet that appeared to have been oxidized can be polished off with sandpaper (100 Grit, VSM Abrasives) and the rest can be ground into powder.

To produce the MXene, the MAX phase can be selectively etched using the MILD method by mixing the generated Ti₃AlC₂ powder with HCl (36.5-38%, VWR International) and LiF (98.5%, Alfa Aesar). Specifically, in a high-density polyethylene (HDPE) bottle, 1 g of Ti₃AlC₂ MAX can be mixed with 2.5 mL of HCl, 7.5 mL of deionized water (DI H₂O), and LiF in a 1:0.85 HCl:LiF molar ratio under continuous stirring. The temperature can then be increased to 50° C. and the stirring can be maintained for 72 h. The etched MXene can be washed multiple times through repeated vacuum filtrations with filter papers including 0.22 μm nitrocellulose membranes (Merck Millipore). The washed MXene can then be vacuum dried overnight with a Schlenk line at ambient temperature. Finally, the resulting MXene powder can be collected and stored in a glovebox filled with Ar.

To synthesize the Ti₃C₂Tₓ/CuM heterostructures, a 6 g/L Ti₃C₂Tₓ stock dispersion and 0.11 M stock solutions of the following salts can be prepared: Cu(NO₃)₂·3H₂O (99-104%, Sigma-Aldrich), AgNO₃ (99.9%, Strem Chemicals), SnCl₂·2H₂O (98-100%, Ward's Science), Zn(NO₃)₂·6H₂O (98%, Sigma-Aldrich), RuCl₃·xH₂O (35-40% Ru, Thermo Fisher Scientific), Ni(NO₃)₂·6H₂O (≤100%, Sigma-Aldrich), and FeSO₄·7H₂O (≥99%, Sigma-Aldrich). In a typical experiment, 125 mL of the MXene stock dispersion can be diluted with ˜118.58 mL of DI water under sonication for 45 min. Then, ˜3.21 mL of Cu nitrate and the same amount of the secondary metal salt of interest can be added to the dispersion and the resulting mixture was sonicated for 15 min and magnetically stirred for an additional 15 min before being washed. In all cases, a Ti:Cu:M molar ratio of 95:2.5:2.5 can be targeted for the Ti₃C₂Tₓ/CuM heterostructures (95:5 Ti:Cu for Ti₃C₂Tₓ/Cu). All the samples can be washed, filtrated, and dried following the same procedure described above.

Powder x-ray diffraction (PXRD) can be used for phase identification using a Bruker D8 Advance x-ray diffractometer equipped with a CuKα radiation. All the samples can be fully packed into the sample holder wells and can be scanned for 15 min between 5° and 80°. Scanning electron microscopy (SEM) images can be collected using a Phenom XL desktop SEM at 10 kV. Scanning transmission electron microscopy (S/TEM) along with energy dispersive x-ray spectroscopy (EDS) and electron diffraction were collected with an FEI Talos S/TEM operated at 200 kV through the Argonne Center for Nanoscale Materials (CNM) user facility program. The S/TEM samples can be prepared by dispersing powders of the MXene heterostructure in DI water and drop-casting the dispersions onto lacey-carbon coated gold grids. X-ray photoelectron spectroscopy (XPS) data can be collected with a Thermo K-Alpha⁺ surface analysis system equipped with AlKα radiation. Ar⁺ ion beam etching was carried out with 4 eV at a 0.2 eV step⁻¹ resolution and a total integration time of 0.1 s point⁻¹. All XPS spectra can be deconvoluted using the Thermo Avantage v5.9931 software package with adventitious carbon (284.8 eV) as the charge reference.

The electrodes used in CO₂RR experiments can be prepared following the procedure illustrated in FIG. 8A and described above with reference to electrode assembly. Briefly, 50 mg of the synthesized MXene heterostructure powders can be mixed with 10 μL of Teflon emulsions (DISP 30, Fuel Cell Earth) and 50 μL of DI H₂O through a 30 min sonication. The resulting inks can then be applied onto both sides of 2×0.5 cm Toray carbon papers (TGP-H-60, Thermo Fisher Scientific), resulting in 25 mg·cm⁻² electrocatalyst loadings. The composition and morphology of the developed electrodes can be identified via XPS and SEM following the same parameters described above.

The CO₂RR experiments can be conducted using H-type electrochemical cells from Adams & Chittenden Scientific Glass with 14 mL electrolyte reservoirs. The same solution can be used as both the catholyte and anolyte (1 M KHCO₃), but the catholyte can be pre-saturated with CO₂ by bubbling the gas (CD I200, Airgas) through the solution for 45 mins. To confirm CO₂ dissolution in the catholyte, gas chromatograms can be collected before and after CO₂ bubbling and the CO₂ peak intensity increased exponentially post-bubbling. The two electrolyte compartments can be separated by a Nafion membrane (N2030WX, Chemours). The MXenes and Ni foils can be used as working and counter electrodes, respectively. Linear sweep voltammetry (LSV) can be conducted to identify CO₂RR active zones with respect to full cell potential. The LSV experiments can be conducted between 0 and −4 V at 20 mV·s⁻¹ using a BioLogic SP-300 potentiostat. The same potentiostat can also be used to drive CO₂RR at select cell potentials through chronoamperometry (CA).

For each electrocatalyst, a series of 15 min CA experiments can be conducted between −1.3 V and −4 V. Upon completion of each CA run, the off-gas contents can be analyzed with gas chromatography/mass spectrometry (GC/MS) before moving to the next potential. All the GC/MS data collection and analysis can be conducted with a Shimadzu GC-2030, equipped with a high temperature range capillary column (330/360° C., SH-Rxi-5ms) as well as a flame ionization detector (FID) and thermal conductivity detector (TCD). GC/MS can also be used to analyze liquid products through injecting aliquots of the catholyte post-reaction. Qualitative identification of products can be completed through comparing GC peak positions (retention times) of the CO₂RR products to the standards while concentrations can be determined through proportionating the same GC peak areas as following:

$${C}_{k} = \frac{{A}_{k} \times {C}_{s}}{{A}_{s}} \qquad Eq . 1$$

where Cₖ is the concentration of product k, Aₖ the GC peak area of product k, Cₛ the concentration of the standard, and Aₛ the GC peak area of the standard. Gases can be analyzed with standards: Shimadzu Scotty specialty gases (100 ppm H₂), GASCO formaldehyde/N₂ gas mix (10 ppm CH₂O), and heated formaldehyde solution (30-50 wt % CH₂O, Sigma-Aldrich).

The concentrations calculated with Equation 1 can then be used to determine faradaic efficiency (FE) through Equation 2 below:

$${FE}_{k} = \frac{{C}_{k} \times {V}_{h} \times {N}_{k} \times F}{{V}_{M} \times {10}^{3} \times Q} \qquad Eq . 2$$

with Cₖ being the GC/MS-derived concentration of gas product k (vol %), Vₕ the headspace volume (mL), Nₖ the number of exchanged electrons, F the Faraday constant (96485 C·mol⁻¹), V_{M} the molar volume of gas product k (V_{M}=RT/P≈24.45 L·mol⁻¹ at 25° C.), and Q the total charge provided to the system (C).

A new figure of merit, “charge-adjusted area” (CAA), can be adopted to assess the efficiency of formaldehyde generation because the concentration of its standards/references can be either very low and close to the detection limit of the GC detector (GASCO CH₂O/N₂ gas mix) or challenging to determine (vaporized CH₂O solution). However, since the CAA trends mirror those of the FE for individual products, it can be determined to be the more appropriate measure for formaldehyde. CAA was calculated using Equation 3 as following:

$${CAA}_{k} = \frac{{A}_{k}}{Q} \qquad Eq . 3$$

where CAAₖ was the charge-adjusted area of product k, Aₖ the GC peak area of product k, and Q the total provided charge in C.

The systems and method of the present disclosure can include systematic hybridization of Cu-based alloys with a two-dimensional MXene, Ti₃C₂Tₓ, and the use of the resulting Ti₃C₂Tₓ/CuM heterostructures as CO₂ reduction electrocatalysts. The hybridization proceeds following a mechanism termed “reductive adsorption” through which the adsorption of the metals triggers the movement of electrons from the MXene Ti core to the adsorbed metals, resulting in the reduction of the latter and the oxidation of the involved Ti moieties. The resulting MXene heterostructures can selectively generate formaldehyde, a non-typical CO₂RR product, at low and industrially relevant cell potentials (−1.4 V to −2.2 V).

A system can include an electrode. The electrode can include a plurality of MXene particles. The electrode can include a binder. The binder can electrically couple the plurality of MXene particles to each other and to a substrate. The substrate can include a current collector. The binder can include a fluoropolymer. The fluoropolymer can include at least one of polytetrafluoroethylene, polyvinylidene fluoride, polyvinylfluoride, polychlorotrifluoroethylene, perfluoroalkoxy polymer, fluorinated ethylene-propylene, polyethylenetetrafluoroethylene, polyethylenechlorotrifluoroethylene, perfluorinated elastomer (perfluoroelastomer), fluoroelastomer (vinylidene fluoride based copolymers), fluoroelastomer (tetrafluoroethylene-propylene), perfluoropolyether, and perfluorosulfonic acid. The electrode can include less than 90 wt % of the plurality of MXene particles. A structure of each of the plurality of MXene particles can be selected from M₂XTₓ, M₃X₂Tₓ, M₄X₃Tₓ, and M₅X₄Tₓ, wherein M includes at least one transition metal, X is selected from carbon and nitrogen, and Tₓ is a surface termination. In some embodiments, at least one metal is adsorbed on each of the plurality of MXene particles.

The electrode can be formed from a slurry. The slurry can include a catalyst (e.g., MXene), water, and a Teflon emulsion. Water can be added to the catalyst before the Teflon emulsion is added. The slurry can be mixed via sonication for greater than or equal to 30 minutes.

FIG. 12 illustrates SEM images for the electrode slurry including a binder with pristine MXene and MXene heterostructures. The binder can include a polytetrafluoroethylene emulsion. The pristine MXene includes Ti₃C₂Tₓ. The MXene heterostructures include Ti₃C₂Tₓ/Cu and Ti₃C₂Tₓ/CuM. Ti₃C₂Tₓ/CuM includes Ti₃C₂Tₓ/CuAg, Ti₃C₂Tₓ/CuSn, Ti₃C₂Tₓ/CuZn, Ti₃C₂Tₓ/CuRu, Ti₃C₂Tₓ/CuNi, and Ti₃C₂Tₓ/CuFe.

### IV. Definitions

No claim element herein is to be construed under the provisions of 35 U.S.C. § 112(f), unless the element is expressly recited using the phrase “means for.”

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A material, comprising:
a MXene;
a first metal adsorbed on the MXene; and
a second metal adsorbed on the MXene, the second metal different from the first metal.

2. The material of claim 1, wherein the first metal comprises copper and the second metal is selected from silver, tin, zinc, ruthenium, iron, nickel, gold, platinum, iridium, palladium, rhodium, cobalt, and osmium.

3. The material of claim 1, wherein a structure of the MXene is selected from M₂XTₓ, M₃X₂Tₓ, M₄X₃Tₓ, and M₅X₄Tₓ, wherein M comprises at least one transition metal, X is selected from carbon and nitrogen, and Tₓ is a surface termination.

4. The material of claim 3, wherein the at least one transition metal is selected from scandium, titanium, vanadium, chromium, yttrium, zirconium, niobium, molybdenum, hafnium, tantalum, and tungsten.

5. The material of claim 3, wherein the at least one transition metal is oxidized.

6. The material of claim 1, wherein the material is configured to perform carbon dioxide reduction.

7. The material of claim 1, wherein the material is configured to produce at least one of formaldehyde, formic acid, carbon monoxide, methanol, methane, ethylene, ethanol, or and propanol.

8. The material of claim 1, wherein at least one of the first metal or the second metal is adsorbed on the MXene at defect sites using a reductive adsorption approach.

9. A method, comprising:
mixing one or more metal salts in solution and a dispersion of a native MXene to form a functionalized MXene mixture, the functionalized MXene mixture comprising a first metal and a second metal adsorbed on the native MXene;
filtering the functionalized MXene mixture to form a filtered functionalized MXene mixture; and
drying the filtered functionalized MXene mixture to form a functionalized MXene solid.

10. The method of claim 9, wherein one or more atoms of at least one of the first metal or the second metal are disposed on at least one of a basal plane of the native MXene or one or more edge sites of the native MXene.

11. The method of claim 9, wherein the native MXene is formed via etching of a MAX phase with a mild approach using HCl and LiF.

12. The method of claim 9, wherein the one or more metal salts in solution comprises a copper nitrate solution.

13. The method of claim 9, comprising:
increasing a concentration of defects of the native MXene via etching or sonication.

14. The method of claim 9, comprising:
performing carbon dioxide reduction with the functionalized MXene solid.

15. The method of claim 9, wherein mixing the one or more metal salts in solution and the dispersion of the native MXene occurs at room temperature.

16. A system, comprising:
an electrode, comprising:
a plurality of MXene particles; and
a binder configured to electrically couple the plurality of MXene particles to each other and to a substrate, the binder comprising a fluoropolymer.

17. The system of claim 16, wherein the fluoropolymer comprises at least one of polytetrafluoroethylene, polyvinylidene fluoride, polyvinylfluoride, polychlorotrifluoroethylene, perfluoroalkoxy polymer, fluorinated ethylene-propylene, polyethylenetetrafluoroethylene, polyethylenechlorotrifluoroethylene, perfluoroelastomer, vinylidene fluoride-based copolymers, tetrafluoroethylene-propylene, perfluoropolyether, and perfluorosulfonic acid.

18. The system of claim 16, wherein the electrode comprises less than 90 wt % of the plurality of MXene particles.

19. The system of claim 16, wherein a structure of each of the plurality of MXene particles is selected from M₂XTₓ, M₃X₂Tₓ, M₄X₃Tₓ, and M₅X₄Tₓ, wherein M comprises at least one transition metal, X is selected from carbon and nitrogen, and Tₓ is a surface termination.

20. The system of claim 16, wherein at least one metal is adsorbed on each of the plurality of MXene particles.
